(19) United States
(12) Patent Application Publication
(10) Pub. No.: US 2023/0271534 A1
(43) Pub. Date: Aug. 31, 2023

(54) CHILD CAR SEAT SYSTEM AND CHILD TRANSPORTATION SYSTEM

(71) Applicant: STROLLEAZI GROUP LIMITED, London (GB)

(72) Inventors: Emma LAWRENCE, London (GB); Jesper TYRER, London (GB)

(73) Assignee: STROLLEAZI GROUP LIMITED, London (GB)

(21) Appl. No.: 18/008,149

(22) PCT Filed: Jun. 4, 2021
(86) PCT No.: PCT/GB2021/051393

§ 371 Date: Dec. 2, 2022

(30) Foreign Application Priority Data
Jun. 4, 2020 (GB) 2008434.9
Mar. 12, 2021 (GB) 2103493.9

(51) Int. Cl. B60N 2/28; B60N 2/00

(52) U.S. Cl. CPC B60N 2/2821; B60N 2/002; B60N 2/2812; B60N 2/2845; B60N 2/2851; B60N 2/2875; B60N 2/2893

(57) ABSTRACT

In some countries, it is a legal requirement for babies, infants and children under a certainage and/or height to be provided with a supplemental car seat when travelling in a vehicle.Furthermore, parents and guardians of children typically make use of a pram to transport a child. However, babies and infants grow quickly and may outgrow conventional car seats and prams within a year or two years. Therefore, a parent or guardian must typically provide several car seats and prams for their child. The present disclosure provides a child car seat system 100 including an infant carrier module 200 that may be releasably docked within a docking module 300 or a wheeled frame 400 to form a car seat and a pram respectively. The infant carrier module 200 may be arranged in an upright position or a lie flat position.

### FIELD OF THE DISCLOSURE

The present disclosure relates generally to a child car seat system and child transportation system and finds particular, although not exclusive, utility in providing a child car seat system and child transportation system that are adaptable to the needs of a child as the child grows.

### BACKGROUND

In some countries, it is a legal requirement for babies, infants and children under a certain age and/or height to be provided with a supplemental car seat when travelling in a vehicle. Such car seats typically improve the child’s safety when travelling in a vehicle, particularly in a collision scenario, when compared to the use of a typical seat belt alone. The shape, size and arrangement of the car seat is typically dependent on the child’s age and/or height. A child may be required to use a so-called baby car seat from birth until approximately 1 year old, a so-called toddler car seat from approximately 1 year old to approximately 4 years old, and a so-called booster seat from approximately 4 years old until the child no longer requires the use of a car seat.

Furthermore, parents and guardians of children typically make use of a perambulator, typically and hereinafter called a pram, to transport a child. The term “pram” used herein if intended to be a reference to a perambulator, buggy, pushchair, stroller, umbrella folding stroller or carriage. A pram may be used to transport babies and relatively young infants, and may provide a relatively horizontal surface for the baby or infant to be transported upon in a flat lying position. A pram may also be used to transport relatively older infants, and may provide a seat arrangement for the infant to be transported in a sitting position.

However, babies and infants grow quickly and may outgrow conventional car seats and prams within a year or two years. Therefore, a parent or guardian must typically provide several car seats and prams for their child.

Aspects of the present disclosure seek to provide an ergonomic car seat system that can be used as a child grows from infant to a toddler and older, typically up to 6 years old. The invention also seeks to provide a versatile arrangement in which components of the car seat system can be used in combination as part of an adaptable pram system.

### SUMMARY

According to a first aspect of the present disclosure, there is provided a child car seat system comprising: a docking module configured to be securable to a vehicle seat; and an infant carrier module configured to receive an infant therein and arranged to be releasably docked with the docking module, the infant carrier module comprising a seat portion attached to a backrest portion via a locking hinge having two locking positions such that the infant carrier module is configurable in: an upright position in which the seat portion and the backrest portion are relatively inclined at a first angle; and a lie flat position in which the seat portion and the backrest portion are relatively inclined at a second angle, greater than the first angle; wherein the system is configured such that the infant carrier module is adjustable within the docking module.

A key advantage of the child car seat system is that the infant carrier module may be undocked from the docking module and used outside of a vehicle in the lie flat or upright position to transport an infant in a lying and sitting orientation respectively, whilst the infant carrier module may be used in the upright position to transport an infant in an upright or sitting orientation whilst travelling in a vehicle. The adjustability and flexibility of the system means that the car seat system may be usable with children of various ages and heights. Furthermore, the infant carrier module may be adjusted within the docking module, such as reclined within the docking module, to provide a more pleasant environment for an infant. Additionally, the child car seat system may be sustainable. In particular, the child car seat system may be adaptable to the needs of a growing child without needing to provide additional components, nor dispose of components as the child grows.

The system may be configured such that the infant carrier module is adjustable within the docking module. In this regard, adjustable may mean that the seat portion and the backrest portion are relatively inclinable. Additionally, or alternatively, adjustable may mean that a headrest portion of the infant carrier module is adjustable in position relative to the backrest portion and/or the docking module. Additionally, or alternatively, adjustable may mean that the infant carrier module is reclinable within the docking module. In this way, the infant carrier module may be adjustable within the docking module, in particular as the child grows and becomes larger. Accordingly, there is no need to provide additional components to continue use of the system with the growing child. Additionally, there is no need to dispose of components as the child grows, thereby providing a sustainable system. Furthermore, the infant carrier module may be the sole seat structure, such that the infant carrier module provides the seat for the infant in all use conditions of the system.

The relative inclinability of the seat portion and the backrest portion may be prevented when the infant carrier module is docked in the docking module. In this way, the infant carrier module may only be docked in the docking module when arranged in the upright or sitting position.

The term ‘infant’ used herein may refer to a toddler or a child.

A child car seat system may be a system configured and intended to be secured to a vehicle and allow for a child to be seated thereon. A child car seat system may modify a typical vehicle seat, which are designed for use by adults, to improve the suitability of the vehicle seat for use with a child.

The docking module being securable to a vehicle seat may mean that the docking module is attachable, releasably or non-releasably, to the vehicle seat or the vehicle such that the docking module rests upon the vehicle seat.

The infant carrier module being releasably docked with the docking module may mean that the infant carrier module may be selectively seated upon and/or secured to, the docking module such that relative movement between the docking module and the infant carrier module whilst docked thereon is at least partially prevented, prohibited, reduced or inhibited.

The seat portion may be a portion of the child car seat system upon which an infant’s bottom and legs may be supported. The backrest portion may be a portion of the child car seat system upon which the infant’s back, arms and head may be supported. The backrest may or may not include a headrest, as discussed herein.

A locking hinge having two locking positions may be any form of rotatable attachment means that allow for the two connected components to relatively rotate, whilst also being securable in at least two relative inclinations.

The first angle may be any angle that provides a conventional sitting arrangement. For example, the first angle may be in the range of 80° to 135°. The second angle may be any angle that provides a conventional lying arrangement. For example, the second angle may be in the range of 135° to 180°. Other angles and ranges are envisaged.

The infant carrier module may be configured to be docked in the docking module only when configured in the upright position. In this way, an infant may be positioned in a seated arrangement when being transported in a vehicle, which may improve and enhance safety. Alternatively, the infant carrier module may be configured to be docked in the docking module when configured in either the upright position or the lie flat position.

The infant carrier module may be releasably securable in the upright position and/or the lie flat position. Additional and/or intermediate positions are envisaged. The locking hinge may comprise suitable locking positions, as required. In this way, the infant carrier module may be arranged at an inclination that is comfortable for an infant. The locking hinge may comprise three, four, five, six or any other number of locking positions, to provide a user with greater flexibility in selecting a suitable inclination angle. In particular, the locking hinge may have four locking positions, with the two locking positions described above in relation to the first aspect of the invention being the relatively most extreme angled positions and the further two locking positions being intermediate positions.

The infant carrier module may further comprise a releasable locking mechanism configured to selectively secure the infant carrier module in the upright position or the lie flat position. The releasable locking mechanism may include an actuator operable to release the locking mechanism and allow the relative inclination of the seat portion and the backrest portion to be adjusted. The actuator may be incorporated into a seat belt guide which may be positioned on a rear of the backrest portion.

The infant carrier module may further comprise an upholstered portion. The upholstered portion may be slidably attached to the backrest portion. The upholstered portion may be configured to translate relative to the backrest portion as the infant carrier module is reconfigured between the upright position and the lie flat position. The seat portion may comprise a seat upholstered portion. The seat upholstered portion may be arranged adjacent to the upholstered portion attached to the backrest portion in all orientations and arrangements of the backrest portion. In this way, a continuous upholstered surface may be provided for the infant.

The infant carrier module may include a harness configured to selectively secure an infant in the infant carrier module. The harness may be stowable within the child car seat system or removable from the child car seat system when the harness is not in use. In a preferred embodiment, the harness is stowed and is not removable from the infant carrier module. In this way, the child car seat system may be arranged for use with an older child, with whom the harness may not be usable. The harness may be removed or preferably stowed and a seatbelt provided in the vehicle may be used to secure the older child. The harness may be a 5-point harness. In a preferred embodiment, only a single harness, rather than two or more harnesses, is provided. In this way, a more convenient system may be provided, and the risk of permanent or accidental misuse may be prevented, thereby providing a safer system.

The infant carrier module may comprise a detachable carrier handle. The carrier handle may be used to carry the infant carrier module, and an infant secured therein, when the infant carrier module is not docked in the docking module. The carrier handle may be configured to be securable to the seat portion and/or the backrest portion at a plurality of angles relative to the seat portion. The carrier handle may comprise an actuator, such as a button or pair of buttons adjacent to the carrier handle hinge points, that a user may actuate to release and reposition the carrier handle. A total of two, three, four, or any other number of positions may be provided. The carrier handle may be detachable by way of a locking clip and release lever. The locking clip may be slid from a secure to a release position, wherein the release lever may be opened, such as through 90°, to release the carrier handle. The carrier handle may then be removed from the infant carrier module. The carrier handle may comprise portions, such as moulded belt guides, suitable for guiding and retaining an automobile seatbelt or lap belt. Said portions may allow the infant carrier module to be secured within a vehicle via the integral seatbelt without, or in addition to, the docking module or ISOFIX connectors.

The outer shell of the infant carrier module may be configured to fit tightly or snugly against the shell portion, such that no or a minimal gap is present. If the carrier handle is configured to attach to the outer shell of the infant carrier module, when the carrier handle removed, a gap may be present between the outer shell of the infant carrier module and the shell portion when the infant carrier module is docked in the docking module. The gap may be caused by the absence of the carrier handle. Alternatively, the carrier handle may be attached to the belt guide region of the infant carrier module. In this way, the carrier handle may attach at a position away from the region of the infant carrier module that fits tightly or snugly against the shell portion, such that no gap is created when the carrier handle is removed.

The docking module may comprise a base portion and a shell portion rotatably attached to the base portion. The infant carrier module may be configured to be releasably docked to the shell portion. In this way, the infant carrier module may be rotatable relative to the base portion and therefore rotatable relative to a vehicle seat to which the base portion may be attached. Accordingly, an infant may be positioned facing forwards, backwards, or there between. The infant may be positioned facing forwards or backwards for travel, and may be moved to a sideways facing position to improve ease of placing or removing the infant from the vehicle. The base portion may comprise ISOFIX connectors. The ISOFIX connectors may releasably yet robustly connect the base portion to the vehicle. The ISOFIX connectors are discussed in more detail below.

The docking module may comprise a forward detent configured to secure the shell portion relative to the base portion in a first rotational position. The docking module may comprise a rearward detent configured to secure the shell portion relative to the base portion in a second rotational position. The second rotational position may be approximately 180° rotated from the first rotational position. The docking module may further comprise a sideways detent configured to secure the shell portion relative to the base portion in a third rotational position. The third rotational position may be approximately 90° rotated from the first rotational position. Other rotational positions are envisaged. A plurality of sideways detents may be provided, at regular or irregular rotational intervals.

The docking module may further comprise a detent release mechanism configured to release the, or each, detent. The detent release mechanism may comprise a button, lever or other actuator operable by a user to release the, or each, detent. The detent release mechanism may comprise a plurality of such actuators, wherein any of the actuators may be actuated to release the, or each, detent. An actuator may be positioned on two or more sides of the child car seat system such that an actuator may be accessible from multiple sides. Accordingly, the actuator may be accessible to a user stood outside of the vehicle when the child car seat is arranged behind either the driver’s seat or the front passenger’s seat.

The child car seat system may further comprise a docking lock mechanism configured to prevent undocking of the infant carrier module from the docking module when the shell portion is secured in the first rotational position or the second rotational position. In this way, the infant carrier module may not be undocked when arranged in the first and/or second rotational positions. The system may comprise an emergency release configured to allow the infant carrier module to be undocked whilst arranged in any orientation, such that an infant may be removed from a vehicle in an emergency situation. The first and second rotational positions may relate to forward and backward facing positions, in use. Accordingly, the docking lock mechanism may provide an additional layer of attachment security between the infant carrier module and the docking module when the child car seat system is configured in an arrangement typically used whilst travelling in a vehicle. The infant carrier module may only be undocked from the docking module when the infant carrier module is rotated to an intermediate rotational position, such as a position facing sideways to the direction of travel. The docking lock mechanism may provide additional strength and security that is particularly important in a vehicular collision or other such scenario.

The docking lock mechanism may be configured to automatically release when the shell portion is arranged between the first rotational position and the second rotational position. In this way, a user may simply unlock the docking lock mechanism by rotating the infant carrier module from a locked position, which would typically occur when a parent is removing an infant from a vehicle. Alternatively, the docking lock mechanism may comprise a release actuator that a user may actuate to release the docking lock mechanism.

The child car seat system may further comprise a secondary safety lock configured to releasably secure the infant carrier module to the shell portion when the infant carrier module is configured in the upright arrangement. The secondary safety lock may be operational at all rotational positions of the shell portion relative to the base portion. The infant carrier module will typically be arranged in the upright arrangement when a vehicle is in motion. Accordingly, the secondary safety lock may provide an additional point of attachment and securement between the infant carrier module and the docking module, which is particularly important when the vehicle is in motion. Failure of a detent or the docking lock mechanism may be remedied by providing the secondary safety lock. In this way, the safety of an infant travelling in the child car seat system is improved.

The system may comprise a rotation limiter. The rotation limiter may be positioned between the shell portion and the base. The rotation limiter may comprise a rotatable selector coupled to at least one, preferably two, lobes having an outer edge that is at least partially elliptical. The selector may be rotatable about an axis that is parallel or coaxial with an axis about which the shell portion may rotate on the base portion. The lobes may be sliadably attached such that they are able to translate towards and away from the selector. The selector may include at least one arm extending away from a central portion, wherein the arm engages with a slot on the lobes. The slot on the lobes may be offset from a central portion of the lobes towards a periphery of the respective lobe. A first end of the slot may be located at a first position with a first radius relative to the axis of rotation of the selector, and a second end of the slot may be located at a second position with a second radius, greater than the first radius, relative to the axis of rotation of the selector. As such, rotation of the selector to cause the arm to move from engagement with the first end of the slot to engagement with the second end of the slot may cause the lobe to translate relatively closer to the selector, and vice versa.

The system may further comprise a limit pin arranged on a lobe and at least one, preferably two, limit stops flanking the lobes. The docking lock mechanism release actuators may be positioned adjacent to the limit stops, also flanking the lobes. The limit stops may be arranged on the base portion such that they are held still whilst the infant carrier module rotates. Rotation of the infant carrier module, with the lobes positioned in an outermost or widest position, may cause the limit pin to engage with the limit stop and prevent rotation of the infant carrier module beyond 90°. Furthermore, rotation of the infant carrier module with the lobes positioned in the outermost or widest position may cause the lobes to engage with the release actuators of the docking lock mechanism to release the docking lock mechanism.

The selector may be operable by a user to position the selector is one of three positions. The first position may be as described above with the lobes outermost. The selector may be arranged in a second position in which the lobes are partially retracted such that the lobes do not engage with the release actuators of the docking lock mechanism, but the limit pin engages with the limit stop. Accordingly, in the second position, rotation of the infant carrier module may be limited by the limit pin, but the infant carrier module may not be released by rotating the infant carrier module to a sideways facing position. The selector may be arranged in a third position in which the lobes are fully retracted such that the lobes are spaced from the release actuators of the docking lock mechanism and the limit pins are spaced from the limit stops in all orientations of the infant carrier module. Accordingly, in the third position, the infant carrier module may be freely rotated through 360° whilst remaining locked in the docking module.

The infant carrier module may be restricted to rearward facing only when the selector is arranged in the first or second positions. The selector may be arranged in the first position only when the infant carrier module is rear facing and has the carrier handle attached. The selector may be arranged in the second position only when the infant carrier module is rear facing without the carrier handle attached. The selector may be arranged in the third position with the infant carrier module in any orientation, without the carrier handle.

The shell portion may be attached to the base portion via a reclining attachment mechanism configured to allow the shell portion to partially or fully recline in a translational and/or rotational manner relative to the base portion when the shell portion is arranged in the first rotational position and/or the second rotational position. In this way, an infant may be reclined for comfort. In some states, regions or countries, there may be a legal requirement for the infant to face in a specific direction whilst travelling. The reclining attachment mechanism may comprise a protrusion translatable within a slot, wherein the shell portion may rotate about the protrusion. Other attachment mechanisms are envisaged. The system may comprise a recline release mechanism including a pull handle operable by a user to withdraw a pin, preferably two pins, from a holding mount. The shell may be moveable along a recline guide with the pin withdrawn. The holding mount may comprise a plurality of pin receiving sections such that the shell is securable in a plurality of positions in the recline guide.

The docking module may include a guide configured to urge the infant carrier module into a docking position. In this way, the infant carrier module may be positioned in the correct position for docking by engaging the infant carrier module with the guide. The guide may comprise a protrusion on one component and a corresponding slot or hole on another component. The guide may comprise any number of such protrusions and slots or holes, such as one, two, three, four or five.

The child car seat system may further comprise a headrest. The headrest may be attached to the backrest portion of the infant carrier module. Additionally, or alternatively, the headrest may be attachable to the docking module. In this way, the headrest may be positioned to provide the optimal comfort and/or safety for the infant. Additionally, the headrest may be moved further from the seat portion as the infant grows. The headrest may comprise an upholstered portion. In this way, a more comfortable and safe headrest may be provided.

The headrest may be slidably attached to the backrest portion. The docking module may comprise a headrest slot. With the infant carrier module docked in the docking module, the headrest may be slidable away from the backrest portion and into the headrest slot. The headrest may comprise a protrusion configured to engage with the headrest slot. In this way, the headrest may be arranged in a position that is comfortable and safe for the infant, which is dependent on the size of the infant. Furthermore, the headrest may be moved as the infant grows. The headrest may be adjustable between a plurality of positions. In this way, the height of the headrest is adjustable dependent on the size of the infant. Preferably, the headrest is adjustable between at least three positions. The headrest may be lockable in the at least three positions. The headrest may be slidably moveable between the at least three positions. The headrest may remain attached to the infant carrier module at all times. In this way, with only a single headrest provided for all arrangements, a more convenient system may be provided. Furthermore, the risk of permanent or accidental misuse may be prevented, thereby providing a safer system.

The child car seat system may further comprise a support leg. The support leg may be rotatably attached to the docking module. The support leg may be rotatable between an extended position in which the support leg extends away from the docking module, and a stowed position in which the support leg lies adjacent to the docking module along a length of the support leg. In this way, the support leg may be extended and arranged to rest on a floor of the vehicle, or may be stowed away. The support leg may be extended when transporting a relatively young infant in a rearward or forward facing position, particularly when the integral harness is used. The support leg may be stowed when transporting a relatively older infant in a forward facing position. The support leg may be length adjustable and securable at a plurality of lengths. The support leg may include a pressure sensor configured to determine a pressure applied to a free end of the support leg such that a desired installation of the support leg is determinable, in use. The system may be configured to provide a visual and/or audible notification when a pressure measured by the pressure sensor falls below a threshold pressure level.

The support leg may be rotatably attached to the docking module via an extendable nose. The extendable nose may be configured to be translatable relative to the docking module along an axis substantially perpendicular to a longitudinal axis of the support leg when the support leg is positioned in the extended position. The extendable nose may be positioned on a front of the docking module and may be translatable out of, and into, the front of the docking module. The child car seat system may further comprise a nose lock configured to secure the extendable nose relative to the docking module. The nose lock may be configured to secure the extendable nose in a plurality of extended positions. In this way, a user may position the support leg correctly or preferably in the foot well of the vehicle. With the extendable nose fully retracted into the docking module, an outer housing of the extendable nose may be flush with an outer housing of the docking module. In this way, the extendable nose, when fully retracted, may be hidden or may not project from the docking module. The extendable nose may comprise a handle arranged such that a user may pull or push the handle to move the extendable nose. The nose lock may be incorporated into the handle. To deploy the support leg, the support leg may be rotated into the extended position and the extendable nose fully extended. The docking module may then be positioned on the vehicle seat. The support leg may only be correctly positioned when the extendable nose is fully extended. The extendable nose may be at least partially retracted such that the support leg is positioned in alternative positions in the foot well of the vehicle. The support leg may then be adjusted in length such that a foot of the support leg is correctly placed on the floor of the vehicle.

The docking module may include a visual indicator. The visual indicator may be configured to indicate a docking status of the infant carrier module in the docking module. Additionally, or alternatively, the visual indicator may be configured to indicate a status of one or more of the ISOFIX connection, the rotation of the system, and the support leg. An associated sensor or sensors may be provided. Any suitable sensor, such as a pressure sensor, a visual sensor, an electrical sensor, or a gyroscopic orientation sensor may be provided. For example, a pressure sensor may be provided on an end of, or in, the support leg and the support leg may be considered to be correctly installed or used if the pressure sensor measures above a threshold pressure or force. An installation notification may be provided once the threshold pressure has been exceeded. Once correctly installed, the pressure sensor measuring a pressure that is below the threshold pressure may be indicative of the support leg becoming dislodged or otherwise becoming incorrectly installed. An error notification may be provided if the measured pressure falls below the threshold level.

The system may further comprise a temperature sensor configured to directly or indirectly measure the temperature of an infant positioned in the infant carrier module. The temperature sensor may be arranged to measure the temperature of ambient air in the vicinity of the infant. The system may provide a measured temperature to a user such as a parent or guardian.

The system may further comprise a motion sensor configured to directly or indirectly measure or detect the presence of an infant positioned in the infant carrier module and/or other seat structure of the system. The other sensors and/or systems may be powered down or in a rest mode until the presence of an infant is detected in the infant carrier module.

Any or each of the indicators and electronic measurements described herein may be provided to a user via an app accessible via a smartphone or other smart device. The system may communicate with a user device via Bluetooth, WiFi, NFC, 3G, 4G, 5G and/or any other suitable communication protocol.

The child car seat system may further comprise an ISOFIX assembly for attachment to a vehicle. The ISOFIX assembly may comprise an extendable arm securable at a plurality of lengths with a ratchet and pawl system. The extendable arm may be biased towards an arrangement in which the extendable arm has a greater length. The ISOFIX assembly may comprise two vehicle locks configured such that both vehicle locks must be released to remove the ISOFIX assembly from the vehicle. The ISOFIX assembly may comprise one or more switches configured to be operated upon connection of the ISOFIX assembly to the vehicle such that a connection status of the ISOFIX assembly is determinable, in use. The ISOFIX assembly may comprise two substantially identical arms, one on each side of the car seat. To install the system, a user may position the ISOFIX arm(s) at the greatest length, secure the arm(s) to the vehicle, and then push the car seat up against the vehicle seat such that the ISOFIX arm(s) reduce in length and are held at the optimal length by the ratchet and pawl.

The child car seat system may be configured and arranged to accept accessories. Accessories may include an umbrella, a sun shade, a rain cover and/or any other accessory known in the art.

The child car seat system may comprise each or any of the features described in relation to any other aspect of the present disclosure.

According to a second aspect of the present disclosure, there is provided a child car seat system comprising: a docking module configured to be securable to a vehicle seat; and an infant carrier module configured to receive an infant therein and arranged to be releasably docked with the docking module, the infant carrier module comprising a seat portion attached to a backrest portion; wherein the system further comprises a docking lock mechanism configured to selectively prevent undocking of the infant carrier module from the docking module.

A key advantage of the second aspect of the present disclosure is that a user may securely dock the infant carrier module within the docking module such that, whilst driving and at other times, the user can ensure that the infant carrier module may not be undocked. Such an arrangement may improve the safety of the system.

The child car seat system may comprise each or any of the features described in relation to any other aspect of the present disclosure.

The child car seat system may further comprise a release actuator configured to be operable to release the docking lock mechanism.

The release actuator may comprise a paddle. The shell portion or the base portion may comprise a paddle stop. Rotation of the shell portion relative to the base portion into the first release position may cause the paddle to engage with the paddle stop such that the release actuator is actuated. In this way, rotation of the shell portion may automatically release the docking lock mechanism when the shell is arranged to face sideways. The paddle may be configured to release the docking lock mechanism when the paddle is moved in either of two opposed directions.

The first release position may be approximately 90° rotated from each of the first and second rotational positions. The child car seat system may further comprise a second release position configured to release the docking lock mechanism. The second release position may be approximately 180° rotated from the first release position. In this way, the docking lock mechanism may be released by rotating the shell to face either sideward direction.

As such, the system may be arrangeable, in use, such that a child positioned in the infant carrier module is facing forwards or backwards relative to a direction of travel when the forward or rearward detent respectively, and the docking lock mechanism may be configured to release when the shell portion is rotated into either sideward facing position.

The visual indicator may be configured to indicate a status of the docking lock mechanism such that a locked or unlocked docking status is displayed.

The paddle may be configured to operate a switch when the infant carrier module is moved to and from the first release position. In this way, an electronic signal may be generated and displayed when the infant carrier module is locked and released.

According to a third aspect of the present disclosure, there is provided a child car seat system comprising: a docking module configured to be securable to a vehicle seat; and an infant carrier module configured to receive an infant therein and arranged to be releasably docked with the docking module, the infant carrier module comprising a seat portion attached to a backrest portion; wherein the infant carrier module comprises a detachable carrier handle configured to be securable to the seat portion and/or the backrest portion.

A key advantage of the third aspect of the present disclosure is that the handle may be used to carry the infant carrier module when it is undocked, but selectively removed when the infant carrier module is docked, such as when the system is used as a car seat for a relatively older infant.

The child car seat system may comprise each or any of the features described in relation to any other aspect of the present disclosure.

The handle may be securable at a plurality of angles relative to the seat portion. In this way, a user may position the handle in a preferred position, for ease of use. The handle may be attached to the seat portion and/or the backrest portion via a handle attachment mechanism. The handle attachment mechanism may comprise at least two tooth forms and a locking cam. The locking cam may be engageable with either of the at least two tooth forms to secure the handle in at least two angles relative to the seat portion. In this way, the handle may be held securely in at least two positions. The handle attachment mechanism may comprise at least four tooth forms. Any number of tooth forms may be provided.

The handle attachment mechanism may comprise a locking cam release actuator operable to disengage the locking cam and the tooth form. The locking cam release actuator may comprise a biased button. The button may be spring biased. Pushing the button may move the locking cam or tooth form out of alignment with the tooth form or locking cam respectively such that the locking cam is rotatable relative to the tooth form and the angle of the handle relative to the seat portion may be adjusted. In this way, a user may reposition the handle by pushing the button and moving the handle to their preferred position. The locking cam may be biased towards the tooth forms such that the locking cam automatically engages with the tooth form when aligned.

The handle attachment mechanism may be configured to releasably attach the handle to the seat portion and/or the backrest portion. The seat portion and/or the backrest portion may comprise a protrusion or a slot. The handle attachment mechanism may be configured to releasably attach to the protrusion or slot. The handle attachment mechanism may comprise a locking cam handle rotatable between a handle locking position, in which the handle is locked to the seat portion and/or backrest portion, and a handle release portion, in which the handle is removable from the seat portion and/or the backrest portion. In this way, the handle attachment mechanism may be unlocked by rotating the locking cam handle, and the handle may then be removed from the car seat system.

The handle attachment mechanism may further comprise a cam handle retaining member configured to releasably retain the cam handle in the handle locking position. The cam handle retaining member may be slidable between a retain position, in which actuation of the cam handle is prevented, and a release position, in which actuation of the cam handle is possible. In this way, to remove the handle, a user must actuate the cam handle retaining member and then actuate the cam handle, thereby reducing the risk of accidental removal of the handle. The cam handle retaining member may be biased towards the retain position. The cam handle retaining member may be sprung biased. In this way, the cam handle retaining member may rest in the retain position.

The handle may be configured to attach to a rear side of the seat portion and/or backrest portion and surround the seat portion and/or backrest portion. The handle may be an enclosed loop. In this way, a relatively strong handle may be provided.

According to a fourth aspect of the present disclosure, there is provided a child car seat system comprising: a docking module configured to be securable to a vehicle seat; and an infant carrier module configured to receive an infant therein and arranged to be releasably docked with the docking module, the infant carrier module comprising a seat portion attached to a backrest portion; wherein the system further comprises a headrest attached to the backrest portion of the infant carrier module and releasably attachable to the docking module.

A key advantage of the fourth aspect of the present disclosure is that as an infant grows, the headrest may be moved up the backrest portion away from the seat portion and connect to the docking module, thereby providing a larger seating area for the infant whilst also providing a secure and reliably support to the headrest.

The child car seat system may comprise each or any of the features described in relation to any other aspect of the present disclosure.

The headrest may be slidably attached to the backrest portion. The docking module may comprise a headrest slot. With the infant carrier module docked in the docking module, the headrest may be slidable away from the backrest portion and into the headrest slot. In this way, the headrest may engage with the docking module to provide additional support to the headrest.

The headrest may comprise a headrest protrusion on a rear side thereof configured to be received within the headrest slot. The headrest protrusion may comprise an enlarged head, and the headrest slot may comprise a first portion having a width larger than a width of the enlarged head and a second portion having a width lesser than the width of the enlarged head. Accordingly, the enlarged head may pass through the first portion of the slot but not the second portion of the slot. Therefore, with the enlarged head positioned adjacent to the second portion of the slot, the headrest may not move away from the slot. Therefore, preferably support and crash characteristics may be achieved.

The docking module may comprise two headrest slots and the headrest may comprise two protrusions. In this way, further support may be provided to the headrest and twisting or rotation of the headrest about an axis parallel to an axial length of either protrusion may be prevented.

The system may further comprise a headrest locking mechanism configured to releasably prevent movement of the headrest relative to the backrest portion. Accordingly, the position of the headrest relative to the backrest portion may be selectively fixed. The headrest locking mechanism may comprise at least one locking pin configured to releasably engage with the headrest and prevent movement of the headrest. The locking pin may be biased towards a position in which the locking pin engages with the headrest. In this way, the rest position of the locking pin may be to secure the position of the headrest, such that a user may not unintentionally leave the headrest loose and moveable.

The system may further comprise a headrest release actuator coupled to the locking pin and operable to disengage the locking pin from the headrest. The headrest release actuator may withdraw the locking pin from the headrest. The headrest release actuator may be coupled to the locking pin via a headrest release component, such as a wire, a chain, an electronic connector, a release linkage or any other suitable component or member. In this way, the headrest release actuator may be positioned away from the locking pin.

A shell portion including the headrest slot may be moveable relative to the backrest portion such that the headrest may, in use, make a secondary movement relative to the backrest portion whilst positioned in the headrest slot. In this way, the headrest may have greater adjustment potential. The system may further comprise a belt guide attached to the shell portion including the headrest slot such that the belt guide is configured to be moveable along with the headrest slot. In this way, a seat belt within the belt guide may be preferably positioned relative to a child within the car seat. The system may further comprise a secondary headrest lever operable to release the shell portion including the headrest slot.

According to a fifth aspect of the present disclosure, there is provided a child car seat system comprising: a docking module configured to be securable to a vehicle seat; and an infant carrier module configured to receive an infant therein and arranged to be releasably docked with the docking module, the infant carrier module comprising a seat portion attached to a backrest portion via a connector portion, wherein the connector portion comprises at least one locking hinge having two locking positions such that the infant carrier module is configurable in: an upright position in which the seat portion and the backrest portion are relatively inclined at a first angle; and a lie flat position in which the seat portion and the backrest portion are relatively inclined at a second angle, greater than the first angle.

The child car seat system may comprise each or any of the features described in relation to any other aspect of the present disclosure.

Each, or any, of the components, such as components operable to connect or reconfigure the infant carrier module, may be provided on the connector portion. For example, the connector portion may comprise the docking lock mechanism and/or the rotation lock mechanism.

The child car seat system may further comprise a carrier handle releasably attachable to the connector portion. The carrier handle may be as described above. The connector portion may provide a relatively strong and stable base for the infant carrier module and connection point for the infant carrier module to dock in the docking module.

The connector portion may comprise one or more sockets configured to receive and releasably retain a protrusion therein such that the infant carrier module is releasably attachable to a wheeled frame comprising one or more protrusions. Alternatively, the connector portion may comprise one or more protrusions configured to be received within, and releasably retained by, one or more sockets such that the infant carrier module is releasably attachable to a wheeled frame comprising one or more sockets.

The seat portion may be rotatably attached to a first side of the connector portion. The backrest portion may be rotatably attached to a second side of the connector portion. The backrest portion and the seat portion may be independently rotatably relative to the connector portion. Alternatively, the rotation of the seat portion may be linked to, or dependent on, the rotation of the backrest portion.

The infant carrier module may comprise a lie flat activation button actuable by a user to disengage the locking hinge and allow the infant carrier module to be configured to the lie flat position. The lie flat activation button may be positioned on a rear of the backrest portion. Pushing the lie flat activation button may pull a locking plunger away from a tooth form and allow rotation relative to the connector portion. The locking plunger may be biased towards the tooth form such that, when the lie flat activation button is released, the locking plunger automatically engages with the tooth form.

The infant carrier module may comprise an upholstered component. The upholstered component may be the upholstered component described above with reference to the first aspect. The upholstered component may be slidably attached to one or more of the seat portion, the backrest portion and the connector portion. The infant carrier module may comprise one or more lie flat connecting arms. The lie flat connecting arms may be attached at a first end to the upholstered section and at a second end to the seat portion or backrest portion such that reconfiguring the infant carrier module between the upright position and the lie flat position moves the upholstered component. In this way, the upholstered component may be moved into a more preferably position automatically by reconfiguring the infant carrier module between the lie flat and upright positions.

Also described is a child transportation system comprising: the child car seat system of the first aspect; and a wheeled frame releasably attachable to the infant carrier module of the child car seat system; wherein, in use with the infant carrier module attached to the wheeled frame, the infant carrier module is configurable in the upright position to form a first pram arrangement and in the lie flat position to form a second pram arrangement.

A key advantage of the child transportation system is that an infant positioned in the child carrier module may be transferred from a vehicle to a pram without being removed from the infant carrier module or otherwise disturbed. Additionally, the child transportation system may be arranged according to the preferences of a user by reconfiguring the child carrier module between the upright position and the lie flat position. Furthermore, the infant carrier module may be attachable to the wheeled frame without need for additional adapters. This feature is discussed in more detail below.

The harness associated with the infant carrier module may be used to secure an infant when the child transportation system is arranged as a pram. The harness may be stowed, as discussed herein, when the child transportation system is arranged as a pram.

The wheeled frame may include two frame portions. The two frame portions may be attached together via two frame hinges. The infant carrier module may be attachable to the wheeled frame such that a first side of the infant carrier module is adjacent to a first of the two frame hinges and a second side of the infant carrier module, opposite the first side, is adjacent to a second of the two frame hinges.

The seat on the wheeled frame may include a so-called bumper bar. The bumper bar may be attached to the seat, and the seat may be attached to the wheeled frame. The bumper bar may be a curved frame member that is attached, at a first end, to a first side of the wheeled frame and is attached, at a second end, to a second side of the wheeled frame. With the seat facing forwards, the bumper bar may extend out toward a front of the wheeled frame, away from a rear of the wheeled frame including a handle portion intended to be pushed or pulled by a user to manoeuvre the wheeled frame. With the seat facing rearwards, the bumper bar may extend out toward a rear of the wheeled frame, away from a front of the wheeled frame. The bumper bar may provide some forward or rearward protection for an infant being transported with the child transportation system. The bumper bar may be configured to be adjustable in angle relative to another frame member. The bumper bar may be fixed in orientation relative to a backrest member. The infant carrier module may be configured to be attachable to the wheeled frame via a bumper bar connection. In particular, the infant carrier module may be configured to attach to the wheeled frame adjacent to the first and second ends of the bumper bar.

The infant carrier module may include a first protrusion on the first side thereof and a second protrusion on the second side thereof. The wheeled frame may include a first socket adjacent to the first frame hinge and a second socket adjacent to the second frame hinge. Alternatively, the infant carrier module may include the first socket on the first side thereof and the second socket on the second side thereof, and the wheeled frame may include the first protrusion adjacent to the first frame hinge and the second protrusion adjacent to the second frame hinge. The sockets may be configured to receive the protrusions therein to attach the infant carrier module to the wheeled base. The sockets may be integrated with the handle or a handle attachment and support structure of the infant carrier module. The infant carrier module may be attachable to the wheeled frame without need for additional adapters, due to the connection features disclosed above. However, adapters may be provided between the wheeled frame and the infant carrier module. The adapters may increase the width of the infant carrier module and may be used when the wheeled frame is arranged in a relatively wide arrangement. The adapters may be removed completely when the wheeled frame is arranged in the relatively narrow arrangement. The wheeled frame may include telescopic frame members configurable to arrange the wheeled frame between two frame arrangements having different widths. In this way, the frame may be arranged in a relatively wide arrangement, for comfort, or a relatively narrow arrangement, for ease of transportation and use.

The telescopic frame members may be locked, such that relative movement is restricted, and unlocked, such that relative movement is possible, by rotating a collar into which the frame members may move to reduce the width of the wheeled frame.

The wheeled frame may include a handle configured to be held, pushed and/or pulled by a user when operating the pram. The handle may be height adjustable. The handle may be provided with an unlock handle which may be rotated or otherwise actuated to release the handle in order for the height of the handle to be adjusted. The unlock handle may be tubular or a sleeve. Frame members may telescope into, or out of, each other to adjust the height of the handle. The handle may be provided with a lock slider. The lock slider may be provided externally or internally. The lock slider may be operable to selectively prevent actuation of the unlock handle.

Cable and spring arrangements may be provided internally to enable the height adjustment of the handle and/or the width adjustment of the wheeled frame.

The handle may be foldable, for storage, transportation, or otherwise. Suitable hinges may be provided in or on the handle to allow for the handle to be folded. Associated levers, buttons or other actuators may be provided to unlock the handle and allow the handle to be folded.

The wheeled frame may be substantially ‘T’ shaped, with wheels provided on two of the three free ends. A folding hinge may be provided at the intersection of the substantially linear parts. The frame may include curved members. For example, one or each of the members of the ‘T’ shaped frame may have a curvature. The curvature(s) may provide a more ergonomic and/or aesthetically pleasing frame.

The wheels of the wheeled frame may be releasably attached and may therefore be removed and replaced. Only the rear, or only the front, wheels may be releasably attached. Alternatively, both the front and rear wheels may be releasably attached. The wheels, in particular the rear wheels, may be replaceable with relatively larger or smaller wheels in diameter and/or width. Any or each of the wheels may be removable or detachable for optimised packaging and shipping. Some or all of the wheels may be provided with a suspension system, such as a spring and damper style suspension system or any other known system. The wheels may be attached to a link bar or axle. For example, two pairs of wheels, each connected to the other wheel of the pair via the link bar or axle. The link bar or axle, along with any associated components such as a brake, may be removeable and replaceable. Relatively large and/or wide wheels may be provided for a relatively comfortable arrangement. Relatively small and/or lightweight wheels be provided for a so-called travel or city configuration. Only the front or only the rear wheels may be replaceable. Alternatively, both the front and rear wheels may be replaceable. In particular, the front wheels may be fixably attached to the frame and the rear wheels, along with the associated link bar or axle, may be replaceable with a second set of rear wheels and associated link bar or axle.

In particular, the frame may be arranged in the relatively wide arrangement, with the relatively large and/or wide wheels attached, to provide a more comfortable arrangement for an infant. Additionally, the frame may be arranged in the relatively narrow arrangement, with the relatively small and/or lightweight wheels attached, to provide an arrangement that may be more lightweight overall, more easily manoeuvred, stored and lifted, and/or more conducive to travel or city living.

Also described is a child car seat system comprising: a docking module; and a detachable infant carrier module arranged to be docked with the docking module, and lifted from the docked condition to separate from the docking module.

The infant carrier module may be nested with the docking module when in the docked condition.

The infant carrier may be reconfigurable between a first configuration in which a support element extends in a first orientation and a second configuration on which the support element extends in a second orientation.

In the first orientation, the support element may extend in a direction across the seat to form a support platform. In such a position the support platform may provide a lie-flat orientation for the infant. A head support portion/headrest may either form part of the support platform or may be connected to move/tilt with the support platform such that the infants head is supported in both the lie flat position, the upright position and any positions intermediate these two extremes.

In the second orientation, the support element may be in an upright orientation and may comprise at least a part of the backrest of the car seat system.

A head support portion/headrest may either forms part of the support platform or is connected to move/tilt with the support platform such that the infants head is supported in both the lie flat position, the upright position and any positions intermediate these two extremes.

The support element of the carrier may be slidably attached to a back-support portion of the infant carrier. The sliding connection of the support element may ascend up the back-support portion as the support element moves from the first orientation to the second orientation.

The docking module may have a seat portion and a backrest portion. The docking module may effectively comprise an under-seat. When the system is converted from infant carriage mode to older child carriage mode, components of the infant carrier module may remain docked with the docking module.

A releasable locking arrangement may be provided enabling the carrier module to be locked in the docked position with the docking module.

The docking module may have a seat portion and a backrest portion, and the locking arrangement is configured to secure the carrier module to the docking module at locking positions provided on both the seat portion and backrest portion of the docking module.

The infant carrier module may be provided with a buckle strap which extends to a buckle. When configured in older child mode, the buckle strap and buckle for use with the seat harness may be secured to a component of the infant carrier module.

The infant carrier module and docking module may be provided with separate head rests.

The infant carrier module may be provided with a detachable headrest. Alternatively, a common headrest may be provided for both modules.

The system may include two separate harness systems, a first harness system associated with the infant carrier module and a second harness system associated with the docking module. In a preferred embodiment, only a single harness is provided. In this way, a more convenient system may be provided, and the risk of permanent or accidental misuse may be prevented, thereby providing a safer system.

The separate harness systems may couple to the same buckle.

The system may be configured to stow the harness associated with the docking module in an inaccessible stowage location when not required for use. The stowage location may be positioned between the carrier module and the docking module. This may enable the harness system for older child use to be stowed away until the conversion of the car seat system from infant mode to older child mode.

The carrier module may comprise a carry handle. The carry handle may be removable to reveal a seat belt, harness or guide channel or formation for a seatbelt or harness.

Also described is a child transportation system comprising a child seat system as defined herein, in combination with a pram system; wherein the infant carrier module is arranged to be mounted and demountable to a frame of the pram; and wherein: i) the rear wheels of the pram are demountable and replaceable by smaller wheels; and/or ii) the width of the frame is arranged to be narrowed/expanded and secured in position at various conditions of narrow/expanded configuration.

A separate sling seat may be provided for the pram.

Any or each of the systems described herein may comprise a power supply system. The power supply system may provide electrical power to any or each of the electronic components described herein. The power supply system may comprise a battery or another portable power source. The battery may be rechargeable and/or replaceable. The display may provide a battery level indicator corresponding to a power or charge level of the battery. Alternatively or additionally, the power supply system may comprise a power cable configured to draw power from the vehicle in which the car seat system is installed. The power supply system may be accessed via a bottom, front or side compartment of the child car seat system such that the power supply system is hidden and/or inaccessible to the infant when the child car seat system is installed in a vehicle. The power supply compartment may be positioned and arranged to be easily accessible to a user, for example without the need for specialist tools or knowledge.

Any or each of the actuators, locks and release mechanisms described herein may be electronically controlled. For example, an actuator may be controlled by a solenoid operable via a push button or some other user operable control. In this way, a user need only press a button or make some other relatively simple action to operate an actuator, such as the rotation release actuator. The push button or other user operable control may be used to wake the system from a sleep or low power mode. The system may be configured to operate and hold the actuator open for a predetermined period of time, such as between 3 and 5 seconds. Other times are envisaged. The actuator may be biased towards a closed position such that, following the expiration of the predetermined period of time, the actuator closes.

According to a further aspect of the present disclosure, there is provided the infant carrier module of any other aspect of the present disclosure.

### EXAMPLE EMBODIMENTS

Example 1: A child car seat system comprising: a docking module; and a detachable infant carrier module arranged to be docked with the docking module, and lifted from the docked condition to separate from the docking module.

Example 2: A child car seat system according to Example 1, wherein the infant carrier module is nested with the docking module when in the docked condition.

Example 3: A child car seat system according to Example 1 or Example 2, wherein the infant carrier is reconfigurable between a first configuration in which a support element extends in a first orientation and a second configuration on which the support element extends in a second orientation.

Example 4: A child car seat system according to Example 3, wherein the infant carrier is reconfigurable, when docked with the docking module, between a first configuration in which a support element extends in a first orientation and a second configuration on which the support element extends in a second orientation.

Example 5: A child car seat system according to Example 3 or Example 4, wherein in the first orientation the support element extends in a direction from front to back of the seat to form a support platform.

Example 6: A child car seat according to any of Examples 3 to 5, wherein in the second orientation, the support element comprises at least a part of the backrest of the car seat system and/or is orientated in an upright position.

Example 7: A child car seat system according to any of Examples 3 to 6, wherein the support element of the carrier is slidably attached to a back-support portion of the infant carrier.

Example 8: A child car seat system according to Example 7, wherein the sliding connection of the support element climbs up the back-support portion as the support element moves from the first orientation to the second orientation.

Example 9: A child car seat system according to any of Examples 1 to 8, wherein the docking module has a seat portion and a backrest portion.

Example 10: A child car seat system according to any of Examples 1 to 9, wherein a releasable locking arrangement is provided enabling the carrier module to be locked in the docked position with the docking module.

Example 11: A child car seat system according to Example 10, wherein the docking module has a seat portion and a backrest portion, and the locking arrangement is configured to secure the carrier module to the docking module at locking positions provided on both the seat portion and backrest portion of the docking module.

Example 12: A child car seat system according to any of Examples 1 to 11, wherein the carrier module is provided with a buckle strap which extends to a buckle.

Example 13: A child seat system according to any of Examples 1 to 12, wherein the carrier module and docking module are provided with separate head rests.

Example 14: A child seat system according to any of Examples 1 to 13, wherein the carrier module is provided with a detachable headrest.

Example 15: A child seat system according to any of Examples 1 to 14, wherein the system includes two separate harness systems, a first harness system associated with the carrier module and a second harness system associated with the docking module.

Example 16: A child seat system according to Example 15, wherein the separate harness systems couple to the same buckle.

Example 17: A child seat system according to Example 15 or Example 16, wherein the system is configured to stow the harness associated with the docking module in a stowage compartment when not required for use, the stowage compartment preferably being positioned between the carrier module and the docking module.

Example 18: A child seat system according to any of Examples 1 to 17, wherein the carrier module comprises a carry handle, the carry handle being removable to reveal a seatbelt or seatbelt guide channel or formation.

Example 19: A child transportation system comprising a child seat system according to any of Examples 1 to 18, in combination with a pram system; wherein the infant carrier module is arranged to be mounted and demountable to a frame of the pram; and wherein: i) the rear wheels of the pram are demountable and replaceable by smaller wheels; and/or ii) the width of the frame is arranged to be narrowed/expanded and secured in position at various conditions of narrow/expanded configuration.

Example 20: A child transportation system comprising: the child car seat system of the first aspect of the present disclosure; and a wheeled frame releasably attachable to the infant carrier module of the child car seat system; wherein, in use with the infant carrier module attached to the wheeled frame, the infant carrier module is configurable in the upright position to form a first pram arrangement and in the lie flat position to form a second pram arrangement.

Example 21: The child transportation system of Example 20, wherein the wheeled frame includes two frame portions attached via two frame hinges, wherein the infant carrier module is attachable to the wheeled frame such that a first side of the infant carrier module is adjacent to a first of the two frame hinges and a second side of the infant carrier module, opposite the first side, is adjacent to a second of the two frame hinges; preferably wherein the seat attached to the wheeled frame includes a bumper bar attached, at a first end thereof, to a first side of the wheeled frame and is attached, at a second end thereof, to a second side of the wheeled frame, further wherein the infant carrier module is configured to be attachable to the wheeled frame via a bumper bar connection such that the infant carrier module is configured to be attachable to the wheeled frame adjacent to the first and second ends of the bumper bar.

Example 22: The child transportation system of Example 21, wherein the infant carrier module includes a first socket on the first side thereof and a second socket on the second side thereof, and the wheeled frame includes a first protrusion adjacent to the first frame hinge and a second protrusion adjacent to the second frame hinge, further wherein the sockets are configured to receive the protrusions therein to attach the infant carrier module to the wheeled base.

Example 23: The child transportation system of any of Example 20 to 22, wherein the wheeled frame includes telescopic frame members configurable to arrange the wheeled frame between two frame arrangements having different widths.

Example 24: The child transportation system of Example 23, wherein the telescopic frame members are locked, such that relative movement is restricted, and unlocked, such that relative movement is possible, by rotating a collar into which the frame members may move to reduce the width of the wheeled frame.

### BRIEF DESCRIPTION OF THE DRAWINGS

The disclosure will be further described in embodiments identified in the accompanying figures in which:

FIGS. 1 to 15 show various views of exemplary assemblies and components of a child car seat system;

FIGS. 16 and 17 show an exemplary first and second pram arrangements respectively for use in a child transportation system;

FIG. 18 is a side view of a child car seat system with an infant carrier module and a docking module;

FIG. 19 is a side view of the infant carrier module of FIG. 18 arranged in the upright position;

FIG. 20 is a side view of the infant carrier module of FIG. 18 arranged in the lie flat position;

FIG. 21 is a perspective view of a wheeled frame for use with the infant carrier module of FIG. 18;

FIG. 22 is a perspective view of the child car seat system of FIG. 18 with the support leg in an extended position;

FIG. 23 is a perspective view of the child car seat system of FIG. 18 with the support leg in a stowed position;

FIGS. 24A, 24B and 24C are a perspectives view of the adjustable headrest of the infant carrier module of FIG. 18 in a plurality of positions;

FIG. 25 is a perspective view of the removably retainable carrier handle on the infant carrier module of FIG. 18;

FIG. 26 is a perspective view of the manual release member of the child car seat system of FIG. 18;

FIG. 27 is a perspective view of the ISOFIX latches of the child car seat system of FIG. 18;

FIG. 28 is a perspective view of a further configuration of the child car seat system and infant carrier module;

FIG. 29 is a perspective view of a portion of the child car seat system of FIG. 28;

FIG. 30 is a perspective view of structural components of the docking module shown in FIG. 18;

FIG. 31 is an exploded view of the infant carrier locking system shown in FIG. 30;

FIG. 32 is an enlarged view of the infant carrier locking system shown in FIG. 30;

FIG. 33 is a sectional view of the infant carrier locking system shown in FIG. 30;

FIG. 34 is an exploded view of the support leg shown in FIG. 18;

FIG. 35 is a sectional view of a lower end of the support leg shown in FIG. 18;

FIG. 36 is a sectional view of a recline system of the docking module shown in FIG. 18;

FIG. 37 is an exploded view of the recline system shown in FIG. 36;

FIG. 38 is a sectional view of an ISOFIX assembly;

FIG. 39 is a further sectional view of the ISOFIX assembly shown in FIG. 38;

FIG. 40 is an exploded view of the ISOFIX assembly shown in FIG. 38;

FIG. 41 is an exploded view of an infant carrier handle assembly of the infant carrier module shown in FIG. 18;

FIG. 42 is a sectional view of the infant carrier handle assembly shown in FIG. 41;

FIG. 43 is an exploded infant carrier handle removal system of the infant carrier module shown in FIGS. 18 and 25;

FIG. 44 is a sectional view of the infant carrier handle removal system shown in FIG. 43;

FIG. 45 is a sectional view of a headrest adjustment system of the infant carrier module shown in FIG. 18;

FIG. 46 is an exploded view of the headrest adjustment system shown in FIG. 45;

FIG. 47 is a side sectional view of a headrest interlock system of the child car seat system shown in FIG. 18;

FIG. 48 is a sectional view of a rotation system of the docking module shown in FIG. 18;

FIG. 49 is an exploded view of the rotation system shown in FIG. 48;

FIG. 50 is an exploded view of the infant carrier module of FIG. 18;

FIG. 51 is a schematic view of a rotation limiter in a first position; and

FIG. 52 is a schematic view of the rotation limiter of FIG. 51 in a third position.

### DETAILED DESCRIPTION

The following description presents exemplary embodiments and, together with the drawings, serves to explain principles of the disclosure. However, the scope of the invention is not intended to be limited to the precise details of the embodiments, since variations will be apparent to a skilled person and are deemed also to be covered by the description. Terms for components used herein should be given a broad interpretation that also encompasses equivalent functions and features. In some cases, alternative terms for structural features may be provided but such terms are not intended to be exhaustive.

Descriptive terms should also be given the broadest possible interpretation; e.g. the term “comprising” as used in this specification means “consisting at least in part of” such that interpreting each statement in this specification that includes the term “comprising”, features other than that or those prefaced by the term may also be present. Related terms such as “comprise” and “comprises” are to be interpreted in the same manner. Directional terms such as “vertical”, “horizontal”, “up”, “down”, “top”, “bottom”, “upper” and “lower” are used for convenience of explanation usually with reference to the illustrations and are not intended to be ultimately limiting if an equivalent function can be achieved with an alternative dimension, orientation and/or direction.

The description herein refers to embodiments with particular combinations of features, however, it is envisaged that further combinations and cross-combinations of compatible features between embodiments will be possible. Indeed, isolated features may function independently as an invention from other features and not necessarily require implementation as a complete combination.

The general descriptive terms “child car seat” and “pram” related to the field of the disclosure are also not intended to be limiting. In the present field there are a wide range of terms applicable to the present disclosure and can be used interchangeably to describe the device, without affecting its scope and interpretation. For example, a “child car seat” can be a catch-all term for a safety device used by a baby, toddler or child for both sitting and/or laying down in a flat position, e.g. a booster seat or carrier respectively. The term “pram” used herein if intended to be a reference to a perambulator, buggy, pushchair, stroller, umbrella folding stroller or carriage.

The first child car seat system 1 comprises a docking module 2, in combination with a detachable infant carrier module 3 arranged to be docked in nested relationship with the docking module 2, and lifted from the docked condition to separate from the docking module 2. The car seat system 1 is intended to provide a single system that can be used to enable a child to be safely secured in a vehicle from an infant right through to an age of up to six years. The docking module 2 provides a base seat that can be secured in the vehicle by ISOFIX fixings. The infant carrier module 3 provides a means for securing the infant in the vehicle (by means of a three-point adult seat belt and also by connection to the docking module 2) and also be demountable to be used as an infant carrier. When secured nested with the docking module 2, the infant carrier module 3 can be reconfigured, for infant comfort, between a lie-flat configuration and an upright configuration. The lie-flat position is the nominal seat angle from birth to approximately 6 months. Then as the baby grows, a support panel or platform 33 is moved from the lie-flat position towards a more upright position and the harness and head support 32 moves up. This will be described in detail. Importantly, as the child grows, the car seat system can be reconfigured to accommodate the larger child, by incorporating the infant carrier module in modified form into the car seat system for the older child, and securing the child with a three-point adult seat belt in the vehicle.

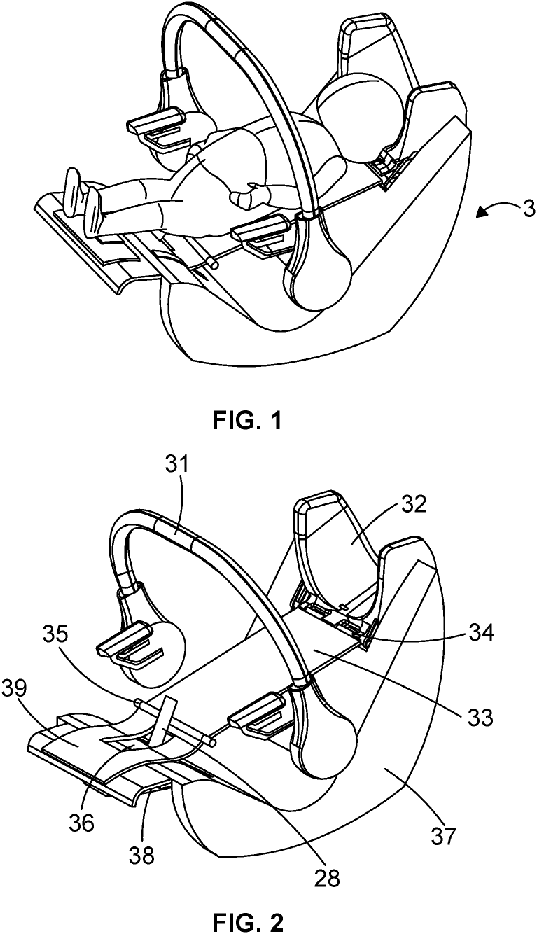

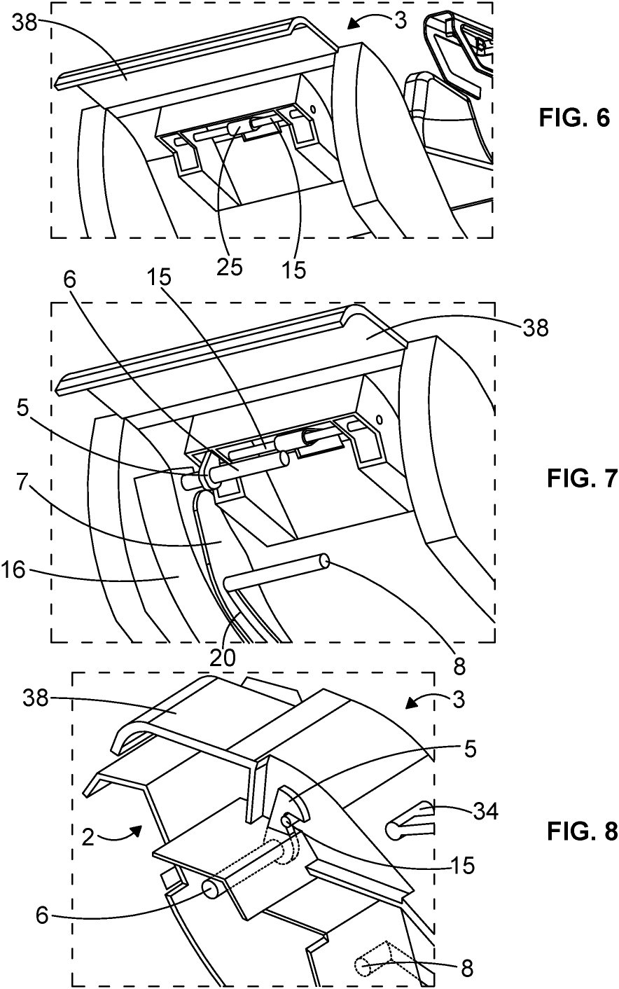

In the figures, the docking module 2 is shown in combination with the docked infant carrier module 3 in FIGS. 7 to 12 and 15. The infant carrier module 3 is shown on its own in FIGS. 1 to 6 and 14. The docking module alone is shown in FIG. 13.

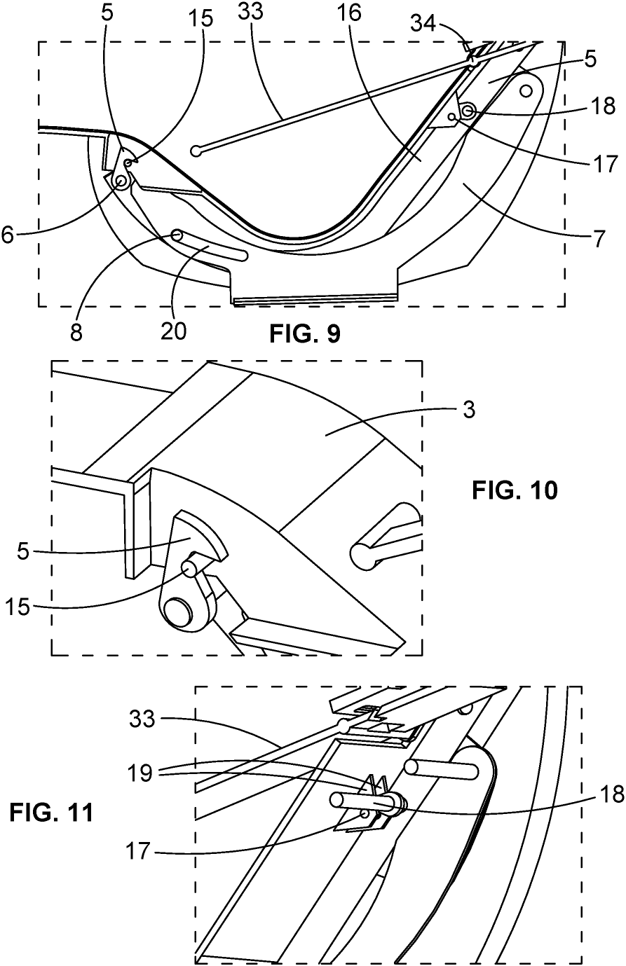

Referring to FIG. 13, the docking module 2 is in the form of a base seat frame having a backrest portion 2a and a seat portion 2b which curves away from the backrest portion 2a. Referring to FIGS. 7 to 12 also, the docking module base seat frame carries latch hooks 5 which are connected to rotatable bars 6 mounted to the base seat frame. The latch hooks 5 are rotatable to a locked position, in order to secure the infant carrier module nested into the docking module base seat frame 2. This is the configuration shown in FIGS. 7 to 10 in which the latches 5 are shown hooked over engaged with a lock bar 15 carried on the underside of the infant carrier module 3. Conversely the bar 6 is rotatable to a release position in which the latch hooks 5 are disengaged from the lock bar 15 and the infant carrier module 3 can be lifted out of nested engagement with the base seat frame docking module 2. Similar latch hooks 5 provided on the backrest portion 2a of the base seat frame docking module 2 are rotatable to engage and disengage with a similar short lock bars 17, provided on the underside of the back-rest portion of the infant carrier module 3. The short lock bars 17 extend between flanges 19 provided on the rear/underside of the infant carrier 3. The latch hooks 5 are provided on rotatable bars 18. In FIGS. 9 and 11 the latch hooks 5 on the docking module back rest 2a are shown engaged (and therefore out of view).

Internally of the docking module 2 are a pair of spaced parallel sub-frame members 7. Sub-frame members 7 provide the chassis of the base frame docking module in combination with a spaced pair of frame members 16. Sub-frame members 7 are provided with arcuate slots 20 within which a follower bar 8 connected to the spaced frame members 16 can slide. This enables the frame members 16 to slide with respect to the sub-frame members 7 to reconfigure the docking module between a reclined condition (as shown in the figures) and an upright seated position. This reconfiguration ability is primarily intended for use to enable reclining and upright orientation when the seat system is in the older child mode.

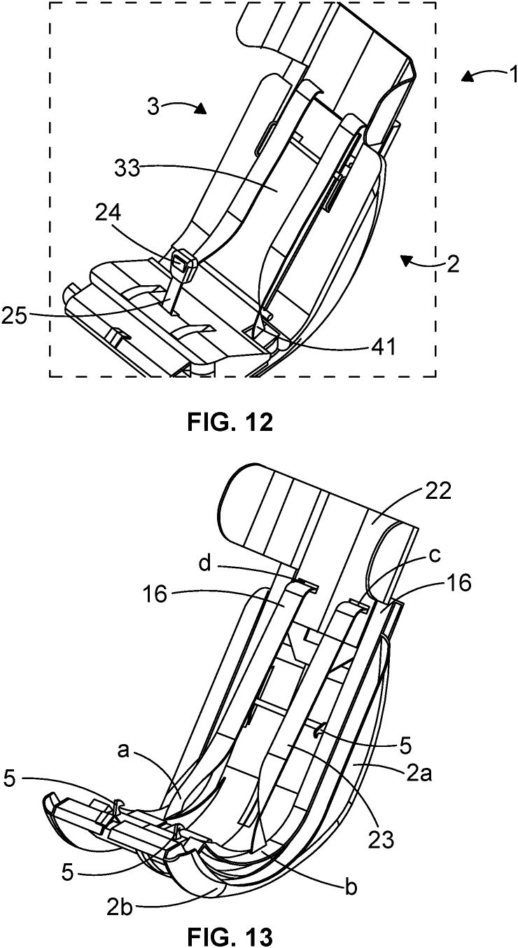

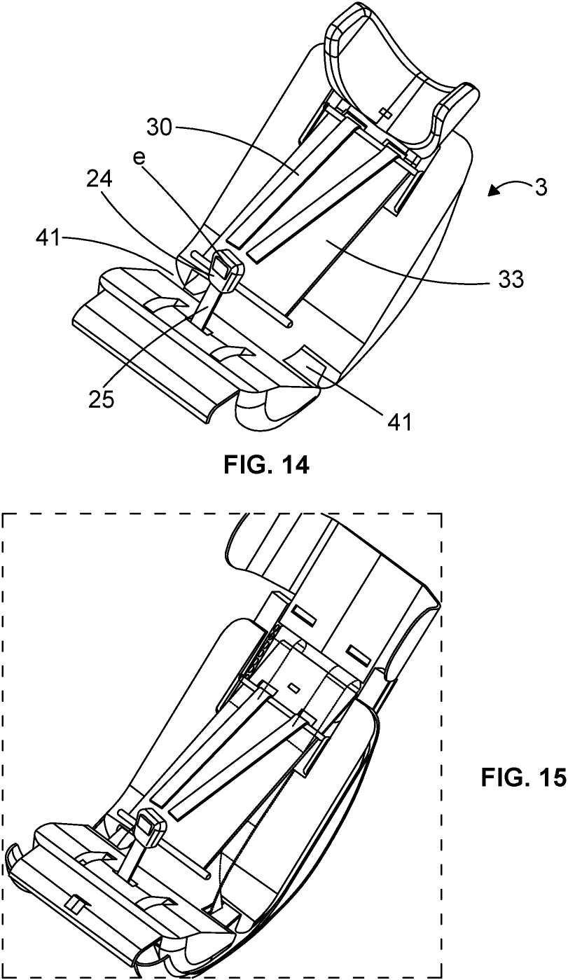

The docking module seat 2 is provided with an adjustable extendible headrest 22 mounted slidably to the frame members 16 and provided with openings for receiving straps of a five-point harness 23. The five points of anchor for the harness 23 are shown as a, b, c, d, and e. Harness anchor points a, b, c, and d are provided on the docking module seat. Harness anchor point e is a buckle 24 connected to the infant carrier module by means of a buckle strap 25 connected to a load bar 15 provided on-board the infant carrier module. The harness 23 is for use when the seat system 1 is converted for older child mode. This configuration is shown in FIG. 12. When in infant seat mode there is a harness system 30 provided on the infant carrier module (see FIG. 14). The older child five-point harness system 23 is, when the system is configured for carrying an infant, stowed between the docking module 2 and the infant carrier module 3. It is of note that when in infant or child carrier mode, the buckle 24 connected to the infant carrier module 3 is used.

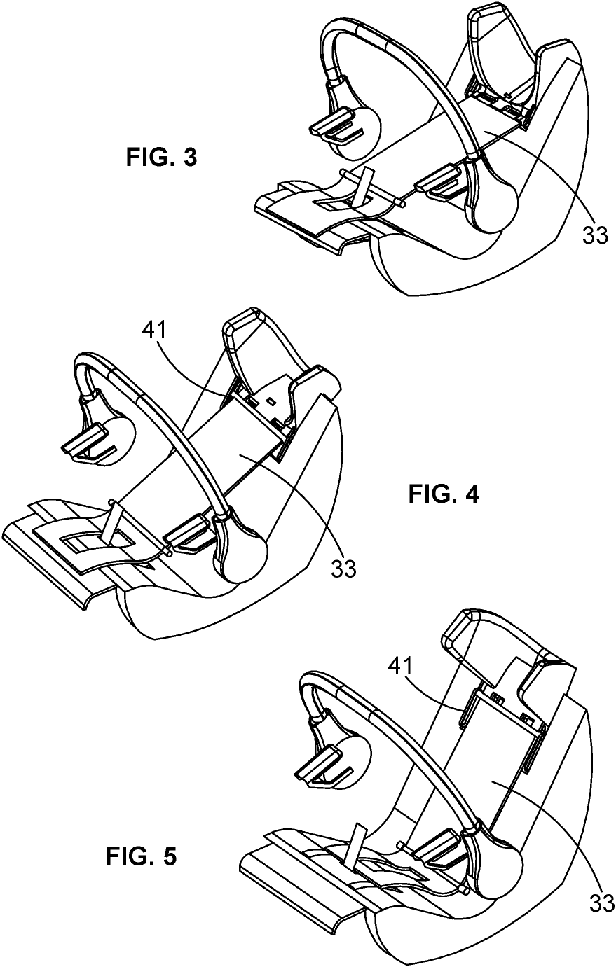

The infant carrier module 3, as shown in FIG. 2, comprises a plastics moulded main body 37 to which is mounted a carry handle 31. The carry handle 31 is demountable from the main body 37 at the juncture at which the system is converted from an infant car seat to an older child, car seat system. The infant carrier module includes an infant support platform 33, which extends between an infant carrier headrest 32 and a sliding footplate 39. Hinge connections 34, 35 are provided connecting the support platform 33 and the headrest 32 and footplate 39 respectively. This permits the support platform 33 and the headrest 32 of the infant carrier to be tilted between a relatively flat position (shown in FIG. 3) and a relatively upright position (shown in FIG. 5). An intermediate position is shown in FIG. 4. The footplate 39 is provided with an aperture 36 through which the buckle strap 25 protrudes and permits the footplate 39 to slide toward or away from the carrier front lip 38, as the support platform re-orientates between the relatively flat, and upright positions. As the support platform 33 re-orientates, the hinge connection 34 slides along the guide slot 41.

The infant carrier module is used as such until the infant grows to a sufficient extent. At this point, a one-time conversion is undertaken in which the carry handle is removed and the infant carrier harness system 30 stowed, for example within the internal fabric of the infant carrier module 3 (or behind the infant carrier module). Removal of the carry handle enables the primary, docking module seat harness system 23 to be accessed via the openings 41. Following this conversion, the car seat system 1 is used in toddler mode with the carrier module 3, effectively being permanently docked with the docking seat module. This configuration is shown for example in FIG. 12, where it can be seen that the infant headrest 32 is removed from the infant carrier module, and the toddler headrest is used which is permanently fitted to the seat system 1 whether in infant or toddler mode.

The infant carrier module 3 provides a means for securing the infant in the vehicle by means of connection to the docking module 2, and also be demountable to be used as an infant carrier. When secured nested with the docking module 2, the infant carrier module 3 can be reconfigured, for infant comfort, between a lie-flat configuration and an upright configuration. In this mode the platform 33 can also be adjusted to a range of intermediate positions between lie-flat and upright. As the child grows, the car seat system can be reconfigured to accommodate the larger child, in a one-time conversion, by incorporating the infant carrier module in modified form into the car seat system for the older child.

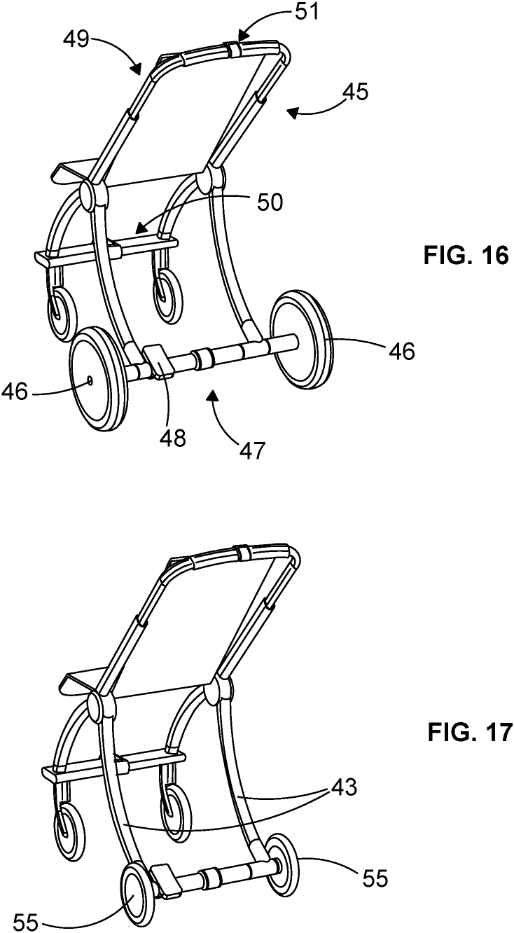

The car seat system can be used in combination with a pram system to provide further versatility. The pram system is shown in FIGS. 16 and 17. In FIG. 16, there is shown a pram 45 which has relatively large rear wheels 46, compared to the forward wheels of the pram. The rear wheels are also set outwardly of the forward wheels to provide enhanced stability. The pram is utilised with the infant carrier module 3 of the car seat system which is arranged to clip to the pram frame in any manner that is known in the art, either in place of the seat 49 or over the seat 49. The rear axle of the frame and also the front lower frame and the handle of the frame are formed using clampable telescoping joints 47, 50 and 51 respectively. A brake 48 is provided acting via a cable arrangement on the rear wheels 46.

The pram mode configuration is shown in FIG. 17. The frame can be expanded using the clampable telescoping joints 47, 50, 51. The large rear pram wheels 46 are removed and replaced with smaller wheels that sit more closely to the stanchions 43. This can clearly be seen by comparison of FIGS. 16 and 17.

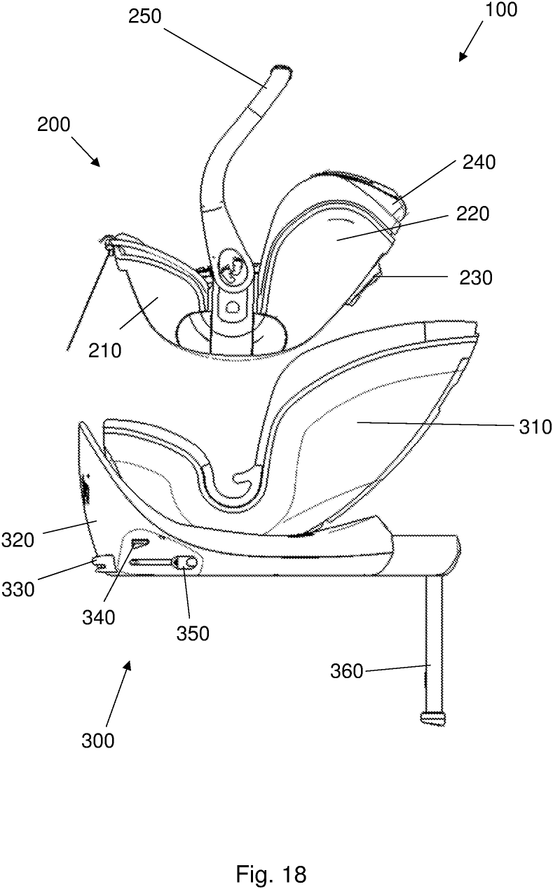

FIG. 18 is a side view of a child car seat system 100 with an infant carrier module 200 and a docking module 300. Any or each of the features discussed above with reference to FIGS. 1 to 17 may also be incorporated into this child car seat system and are not discussed again for brevity.

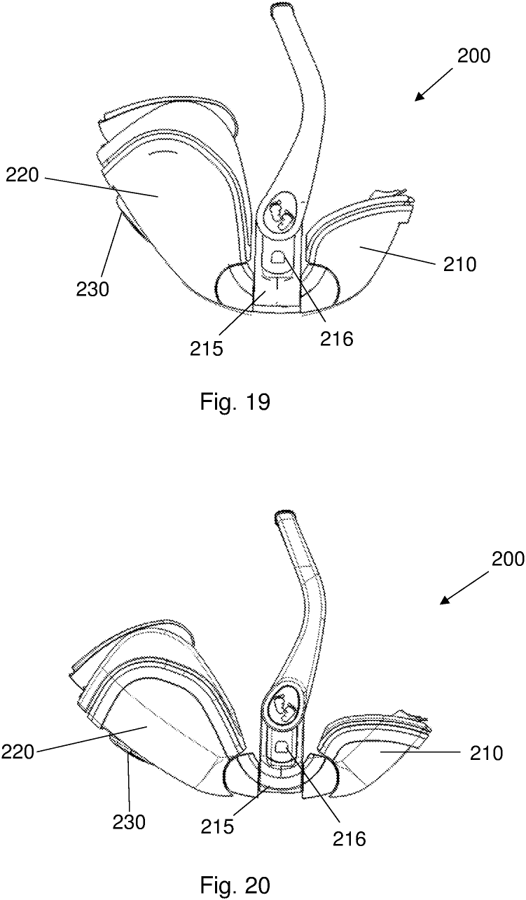

The child car seat system 100 includes an infant carrier module 200 and a docking module 300. An infant may be positioned in the infant carrier module 200. The infant carrier module 200 includes a seat portion 210 and a backrest portion 220 rotationally attached thereto. The relative rotation of the seat portion 210 and the backrest portion 220 is discussed in more detail with reference to FIGS. 19 and 20. A release actuator 230 is provided on a rear side of the backrest portion 220. Actuating the release actuator 230 unlocks the hinge connecting the seat portion 210 and the backrest portion 220 and allows the relative inclination between seat portion 210 and the backrest portion 220 to be adjusted. The release actuator 230 may be incorporated into a seat belt guide.

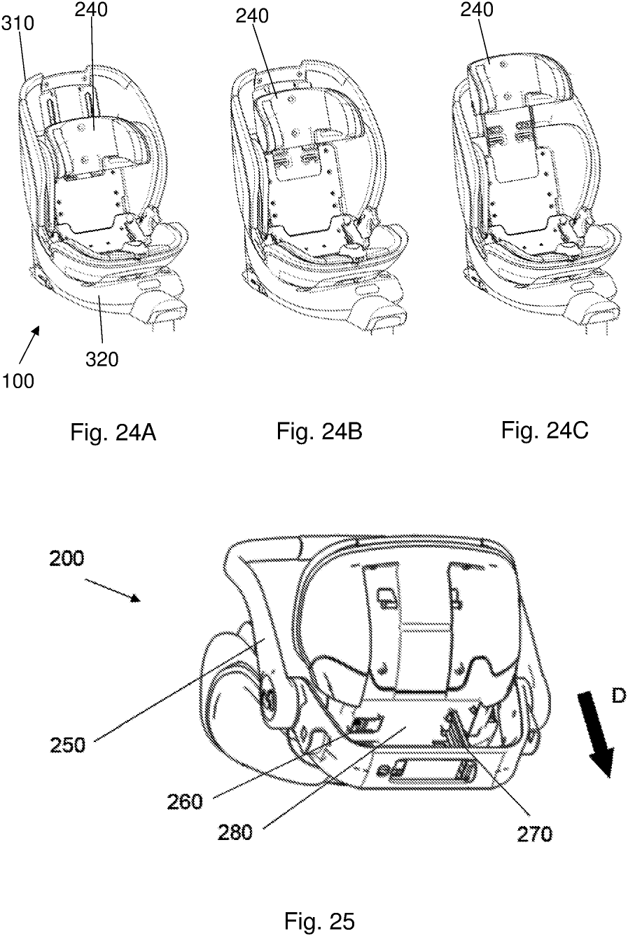

The infant carrier module 200 also includes a headrest 240, as illustrated in FIGS. 24A-24C, and a carrier handle 250. An infant may be positioned in the infant carrier module 200 with their bottom and legs supported by the seat portion 210, their back and arms supported by the backrest portion 220, and their head supported by the headrest 240. The headrest 240 is slidably adjustable between a first headrest position, shown in FIG. 24A, a second headrest position, shown in FIG. 24B, and a third headrest position, shown in FIG. 24C. As the child grows, the position of the headrest 240 can be adjusted. The headrest 240 can be locked into position to prevent accidental adjustment of the headrest 240 height.

An integral upholstered portion may be provided covering the seat portion 210, the backrest portion 220 and the headrest 240, for comfort. An integral harness may also be provided to secure the infant into the infant carrier module 200. The harness may be stowable within the infant carrier module 200 when not in use. The infant carrier module 200, and an infant positioned therein, may be carried by way of the carrier handle 250. The carrier handle 250 may be adjustable rotationally in angle relative to the seat portion 210 and/or the backrest portion 220.

The carrier handle 250 can be removed from the infant carrier module 200, as illustrated in FIG. 25. The infant carrier module 200 comprises a carrier handle locking clip 260 and a carrier handle locking member 270 located on a carrier handle connecting portion 280. In a first configuration, the carrier handle locking clip 260 and a carrier handle locking member 270 are in a locked mode, wherein the carrier handle 250 is locked to the infant carrier module 200. A portion of the carrier handle locking member 270 passes through the carrier handle 250, securing the carrier handle 250 against the carrier handle connecting portion 280. In a second configuration, the carrier handle 250 can be removed from the infant carrier module 200.

To remove the carrier handle 250 from the infant carrier module 200, a user can manually release the carrier handle locking clip 260, allowing the carrier handle locking member 270 to rotate 90 degrees relative to the carrier handle connecting portion 280. In this second configuration, wherein the carrier handle locking member 270 is normal to the carrier handle connecting portion 280, the handle bar 250 can be moved in direction D. In this way, the carrier handle locking member 270 no longer passes through a portion of the carrier handle 250, such that the carrier handle 250 can be entirely removed from the infant carrier module 200. The carrier handle 250 allows the infant carrier module 200, and an infant positioned therein, to be carried by way of the carrier handle 250. However, wherein the carrier handle 250 is removably retained on the infant carrier module 200, the infant carrier module 200 can easily be docked to the docking module 300 with or without the carrier handle 250.

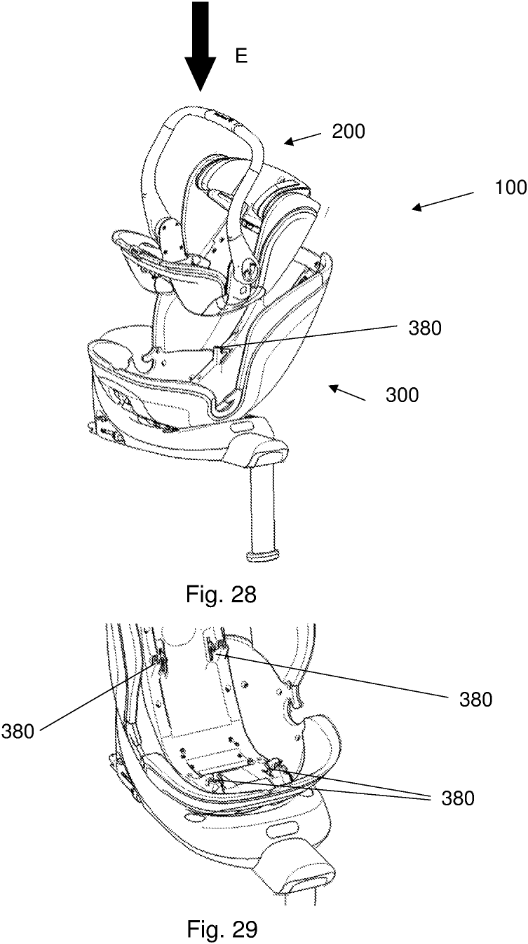

The infant carrier module 200 may be releasably docked in the docking module 300. The docking module 300 includes a shell portion 310, into which the infant carrier module 200 may be docked, and a base portion 320, which supports the shell portion 310. The shell portion 310 includes four locking guides, as illustrated on FIGS. 28 and 29. The four locking guides 380 form a locking mechanism 380 that engages with the infant carrier module 200, as the infant carrier module 200 is docked, to ensure that the infant carrier module 200 is positioned and aligned correctly to engage with a locking mechanism 380, and possibly a further locking mechanism, if provided. The infant carrier module 200 is docked by lowering the infant carrier module 200 in direction E onto the docking module 300. The locking mechanisms 380 (and the further locking mechanism, if provided) releasably attaches the infant carrier module 200 to the shell portion 310. Each of the locking guides includes a locking hook that locks the infant carrier module 200 automatically when the shell portion 310 is rotated into a position intended for travel. The shell portion 310 is similarly shaped to the infant carrier module 200 such that, when docked, the infant carrier module 200 fits relatively snugly within the shell portion 310. The shell portion 310 provides protection and additional security to the infant carrier module 200.

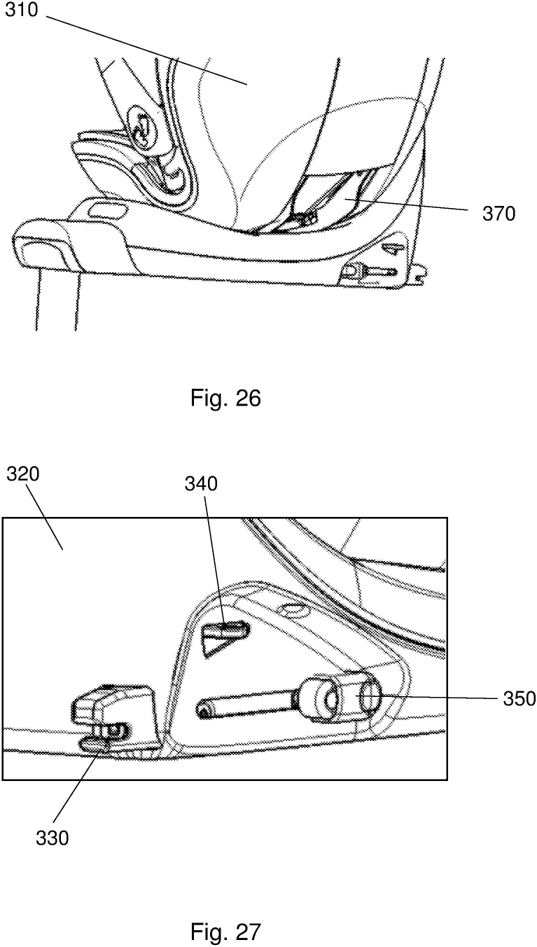

The shell portion 310 is rotatable within the base portion 320 about an axis running approximately vertically in the view shown in FIG. 18. The shell portion 310 is shown in a rearward facing direction, but the shell portion 310 may be arranged in any orientation, such as forward facing or sideways facing. The shell portion 310 may be lockable in a rearward facing direction or a forward facing direction, as is typically used when travelling. The locking mechanisms 380 (and the further locking mechanism, if provided) are configured such that the carrier module 200 is only locked in the docking position when it is in a rearward or forward facing position. Further, the locking mechanisms 380 (and the further locking mechanism, if provided) are configured such that the locking mechanisms 380 (and the further locking mechanism, if provided) automatically locks when the carrier module 200 is docked in the rearward or forward facing position. A rotation release button may be provided on one or more sides of the docking module 300 to release the rotational locking positions. Additionally, the shell portion 310 may be reclinable within the base portion 320. In particular, the shell portion 310 may be reclinable within the base portion 320 when the shell portion 310 is arranged in the forward facing arrangement, for comfort. The shell portion 310 further comprises a manual release member 370 for manually locking and releasing the infant carrier module 200 to the docking module 300. The manual release member 370 is operable only when the carrier module 200 is in an unreclined configuration, as shown in FIG. 26. In this way, the manual release member 370 acts as a secondary safety lock.

As illustrated in FIG. 27, the base portion 320 includes ISOFIX latches 330 to allow the base portion 320 to be securely connected to a vehicle. ISOFIX installation levers 340 are and cause the ISOFIX latches 330 to slide out when pressed. In some examples, the levers 340 may instead be buttons. ISOFIX sliders 350 are provided to decouple the ISOFIX connectors 330. When installed, the ISOFIX sliders 350 will indicate that the ISOFIX latches 330 are correctly installed, and may be slid to decouple the ISOFIX latches 330.

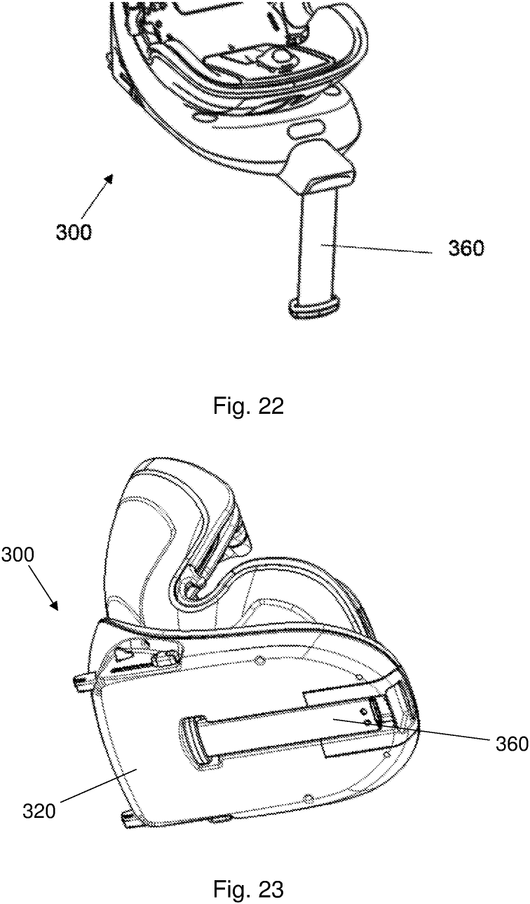

The docking module 300 also includes a support leg 360 configured to extend from the base portion 320 to the floor of the vehicle. The support leg 360 may be rotatably attached to the base portion 320 such that the support leg is movable between an extended position, as shown in FIG. 18, and a stowed position wherein the support leg 360 lies adjacent to the base portion 320. The extended position of the support leg 360 is further shown in FIG. 22 and the stowed position of the support leg 360 is illustrated in FIG. 23. As the support leg 360 can be stowed away adjacent to the base portion 320 as the child grows, this allows the docking module 300 to be reconfigured to accommodate the larger or older child.

FIG. 19 is a side view of the infant carrier module 200 of FIG. 18 arranged in the upright position. In the upright position, the seat portion 210 and the backrest portion 220 are relatively inclined at an angle between 120° and 90°, such as approximately 100°.

Accordingly, an infant positioned in the infant carrier module 200 may be sitting in an upright position. The relative inclination between the seat portion 210 and the backrest portion 220 may be adjusted by way of the release actuator 230, such that the infant carrier module may be arranged in the lie flat position, as shown in FIG. 20.

FIG. 20 is a side view of the infant carrier module 200 of FIG. 18 arranged in the lie flat position. In the lie flat position, the seat portion 210 and the backrest portion 220 are relatively inclined at an angle greater than that of the upright position. Accordingly, an infant positioned in the infant carrier module 200 may be lying in a flat position. The relative inclination between the seat portion 210 and the backrest portion 220 may be adjusted by way of the release actuator 230, such that the infant carrier module may be arranged in the upright position, as shown in FIG. 19.

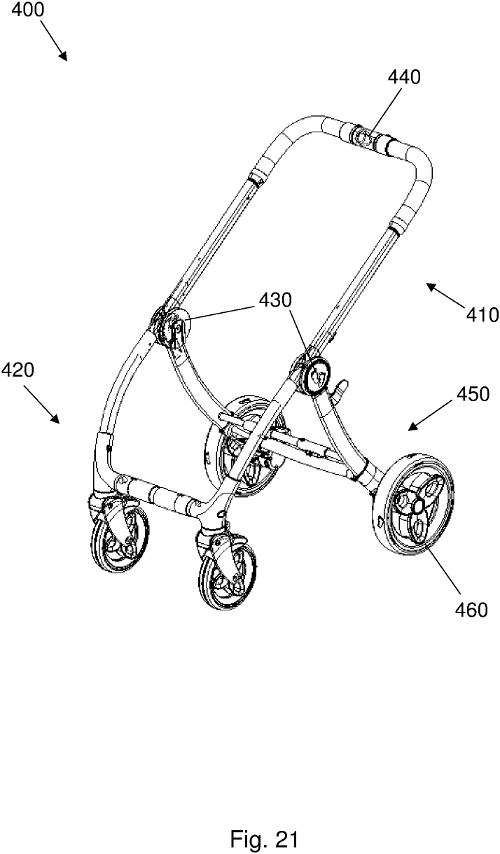

The infant carrier module 200, as shown in FIGS. 19 and 20, includes a connector portion 215 between the seat portion 210 and the backrest portion 220. As can be seen in FIGS. 19 and 20, the connector portion 215 remains static when the seat portion 210 and the connector portion 220 move. The carrier handle, as discussed with reference to FIG. 18, is rotatably and releasably connected to the connector portion 215. The connector portion 215 may also include sockets or protrusions configured to engage with a wheeled frame, as discussed with reference to FIG. 21, to attach the infant carrier module 200 to the wheeled frame and form a pram. Additionally, the connector portion 215 includes a belt guide 216 on each side of the infant carrier module 200. The belt guides 216 are configured to receive and retain a seatbelt or lap belt of a vehicle therein. As such, the infant carrier module 200 may be secured in a vehicle with the integrated seatbelt or lap belt of the vehicle.

FIG. 21 is a perspective view of a wheeled frame 400 for use with the infant carrier module of FIG. 18. The wheeled frame 400 includes a telescopic handle section 410 attached to a front wheel section 420 via locking hinges 430. A portion of the handle section 410 may be moved telescopically into or out of another portion to reduce or increase a height of the handle section 410. The handle section includes a locking and unlocking actuator 440 positioned at a proximal end of the handle section 410 intended to be held by a user when pushing or pulling the wheeled frame 400. The locking actuator 440 may be used to lock or unlock the telescopic function of the handle section 410, in particular by sliding or rotating a portion of the locking actuator 440.

The wheeled frame 400 also includes a rear wheel section 450 attached to the front wheel section 420 via the locking hinges 430. The locking hinges 430 may therefore be three way hinges. The wheeled frame 400 may be arranged in a pram configuration, as shown in FIG. 21, wherein the handle portion 410 and the front wheel portion 420 are substantially linear and the rear wheel section 450 extends away from the handle section 410 and the front wheel section 420 to form a generally ‘T’ shaped frame. Alternatively, the hinges 430 may be released and the wheeled frame 400 may be arranged in a collapsed arrangement in which the handle section 410, the front wheel section 420 and the rear wheel section 450 are adjacent to each other. The collapsed arrangement may be particularly suitable when transporting the wheeled frame 400. To collapse the wheeled frame, a user may perform a second actuation on the locking actuator 440, such as sliding or rotating a second component, or rotating the first component in a different direction and releasing the secondary, which may be achieved via a sliding button on the handle portion 410 or otherwise.

Each of the sideways connecting frame members, shown as the horizontal members in FIG. 21, of the wheeled frame 400 may be adjustable in length to adjust a width of the wheeled frame 400. The sideways connecting frame members may be telescopic or otherwise length adjustable. The locking actuator 440 may be actuated in a third manner to release a sideways locking of the wheeled frame 400 to allow for the width of the wheeled frame 400 to be adjusted.

The rear wheel section 450 includes rear wheels 460. The rear wheels 460 are releasably attached such that they are replaceable. The rear wheels 460 may be removed individually. Alternatively, the rear wheels 460 may be removed as a pair along with the connecting axle. A relatively large set of rear wheels 460 are shown in FIG. 21. Relatively large wheels may provide a more comfortable ride than relatively smaller wheels. Relatively smaller replacement wheels may be provided, such as a set of wheels equivalent in size to the wheels of the front wheel section 420.

The infant carrier module 200 shown in FIGS. 18 to 20 may be attached to the wheeled frame to form a pram, depending on the configuration of the components. The infant carrier module 200 may attach to the wheeled frame 400 at points adjacent to the attachment points of the carrier handle 250 of the infant carrier module 200, for stability. The infant carrier module 200 may attach to the wheeled frame 400 between the locking hinges 430, without the need for additional adapters. The angle at which the infant carrier module 200 is supported by the wheeled frame 400 may be adjustable. The infant carrier module 200 and/or the wheeled frame 400 may include a bumper bar which may be adjustable in angle along with the backrest of the infant carrier module 200. The bumper bar may be releasably attached to the seat portion of the pram, which may be formed by the infant carrier module 200. A collapsible and stowable canopy may also be provided to cover or shade the infant carrier module 200.

Additionally or alternative features and/or arrangements may be provided, as will be clear from the full disclosure made herewith. In particular, features described with reference to any aspects of the disclosure, or the other systems described, may be incorporated into any of the other aspects or disclosures.

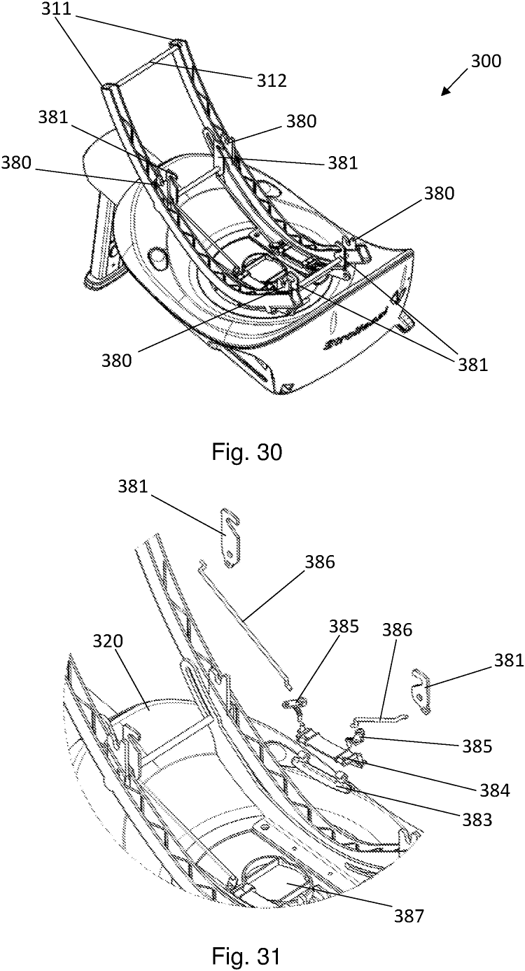

FIG. 30 is a perspective view of structural components of the docking module 300 shown in FIG. 18. The shell portion (not shown) includes two substantially parallel curved frame members 311 separated and held apart by a plurality of cross members 312. The frame members 311, 312 provide a stiff and supportive backbone to the shell portion and to an infant positioned in the child car seat system. The locking guides 380 are connected to the frame members 311, 312 and extend through the shell portion to guide the infant carrier module (not shown) into the correct position for docking. The docking module includes four locking latches 381 connected in two pairs of two latches. The locking latches 381 are configured to hook over corresponding components on the rear of the infant carrier module (not shown) to hold the infant carrier module adjacent to the docking module 300.

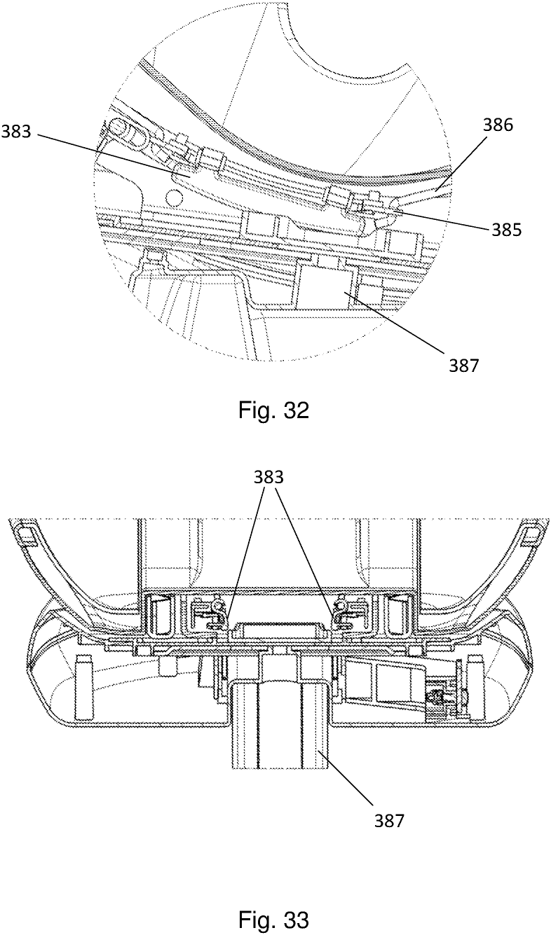

FIG. 31 is an exploded view of the infant carrier locking system shown in FIG. 30. FIG. 32 is an enlarged view of the infant carrier locking system shown in FIG. 30. FIG. 33 is a sectional view of the infant carrier locking system shown in FIG. 30. As shown in FIG. 30, the locking system includes locking latches 381. The locking latches have hooked ends configured to hook over corresponding components on the rear of the infant carrier module. The hooked ends of each pair face towards each other to ensure a secure connection is provided. The locking latches 381 are operated by a paddle 383 rotatable relative to a locking housing 384 that is fixed to the docking module 300. Actuating the paddle 383 operates and rotates locking levers 385, which in turn pull on locking wires 386. The locking wires 386 are connected to the locking latches 381 and, when the locking wires 386 are pulled, pull on locking latches 381 and rotate the locking latches 381 such that the hooked ends are held away from the corresponding components on the infant carrier module. Although wires are depicted, any other suitable component may be provided. When the hooked ends are moved away from the corresponding components on the infant carrier module, the infant carrier module may be undocked from the docking module 300.

Rotation of the shell portion within the base portion 320 to a sideward facing direction, as described above, may cause the paddle 383 to press against a part of the base portion 320, such as a release moulding 387 protruding from a top surface of the base portion 320, and be actuated automatically. With the shell portion positioned to face sideward, the locking latches 381 are held apart or open such that the infant carrier module may be docked or undocked freely. As and when the shell portion is rotated away from the sideward facing direction toward a forward or rearward facing direction, the paddle 383 disengages from the release moulding 387 and the locking latches 381 hook over the corresponding components on the rear of the infant carrier module to retain the infant carrier module in a docked configuration. A second paddle 383 and corresponding linkage members, operationally identical to that described above, is provided to actuate, lock and unlock the locking latches 381 on the opposite side of the release moulding 387.

FIG. 34 is an exploded view of the support leg 360 shown in FIG. 18. The support leg 360 is connected to the base portion (not shown) via a support leg bracket 361A, a pivot bracket 361B and a support leg pivot bar 361C. The support leg bracket 361A is configured to be fixed to the base portion of the docking module. The support leg 360 is pivotable about the support leg bracket 361A via the pivot bracket 361B and the support leg pivot bar 361C. The pivot bracket 361B and the support leg pivot bar 361C are arranged such that the support leg 360 is able to move through at least 90° of rotational motion, from a stowed position to a deployed or extended position. The support leg 360 comprises an upper support leg 362A and a lower support leg 362B that is telescopically received within the upper support leg 362A such that the support leg 360 is length adjustable. A support leg end cap 363A is provided to cover the lower end of the lower support leg 362B, and upper foot moulding 363B and lower foot moulding 363C are provided adjacent to the support leg end cap 363A to form an enlarged foot having desirable support and gripping properties.

Various housings and covers, including support leg upper nose moulding 364A, support leg lower nose moulding 364B, rear upper cover 364C and support leg release housing 364D are provided to cover the mechanical connections of the support leg 360 for safety and improved aesthetics.

The support leg 360 is securable in a plurality of lengths. A support leg locking pin 365 engages with the upper support leg 362A and the lower support leg 362B to prevent relative movement and adjustment of the length of the support leg 360. A support leg release button 366, on a rear side of the support leg 360, is actuable by a user to release the support leg locking pin 365 and allow for relative movement between the upper support leg 362A and the lower support leg 362B to adjust the length of the support leg 360. A spring 367 is provided to bias the upper support leg 362A away from the lower support leg 362B. A further spring may be provided to bias the support leg locking pin 365 into a position in which adjustment of the length of the support leg 360 is prevented.

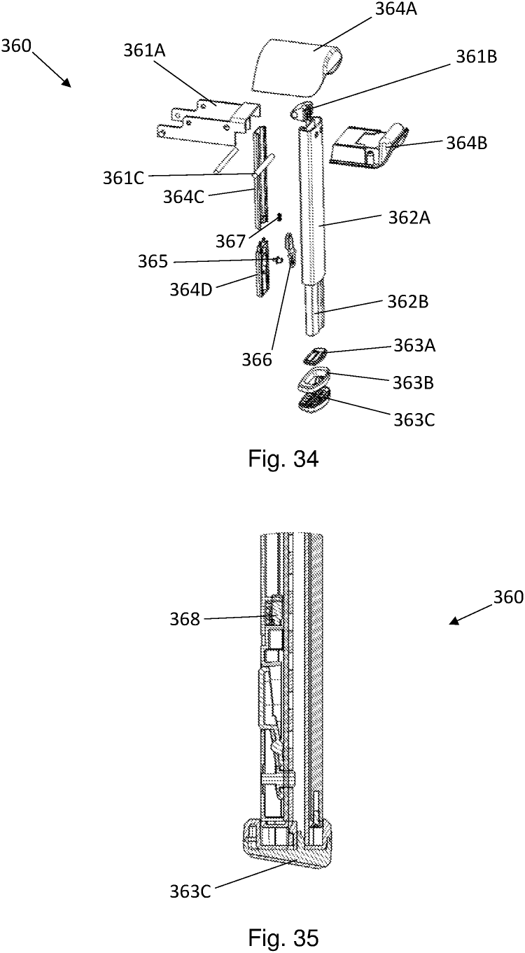

The support leg upper nose moulding 364A and support leg lower nose moulding 364B combine to form a nose. The nose carries the pivot bar 361C such that the support leg 360 is pivotable about the nose. The nose is slidably attached to the docking module along an axis perpendicular to the upper support leg 362A and generally left to right in the arrangement shown in FIGS. 34 and 35. The nose may translate between a fully retracted position, in which the nose mouldings 364A, 364B are generally flush with the housing of the docking module, and a fully extended position in which the nose mouldings 364A, 364B protrude from the docking module. The nose may be securable in a plurality of positions at and/or between the fully retracted and fully extended positions.

In use, a user may deploy the support leg 360 by pivoting the support leg 360 about the pivot bar 361C, extend the nose to the fully extended position, and position the docking module on the vehicle seat, press the support leg release button 366 to disengage the locking pin 365 and adjust the length of the support leg 360 such that the lower foot moulding 363C presses against the floor of the vehicle. The nose may be at least partially retracted from the fully extended position for reasons other than to correctly position the support leg 360.

FIG. 35 is a sectional view of a lower end of the support leg 360 shown in FIG. 18. The support leg 360 includes a pressure activated switch 368 that is set when a sufficient pressure above a threshold level is applied by the support leg 360, via the lower foot moulding 363C, to the floor of the vehicle. The switch 368 may then be activated when the pressure falls below the threshold level and provide an output. The output from the switch 368 may be used to provide a visual and/or audible notification to the user that the support leg 360 is correctly set up for use within a vehicle.

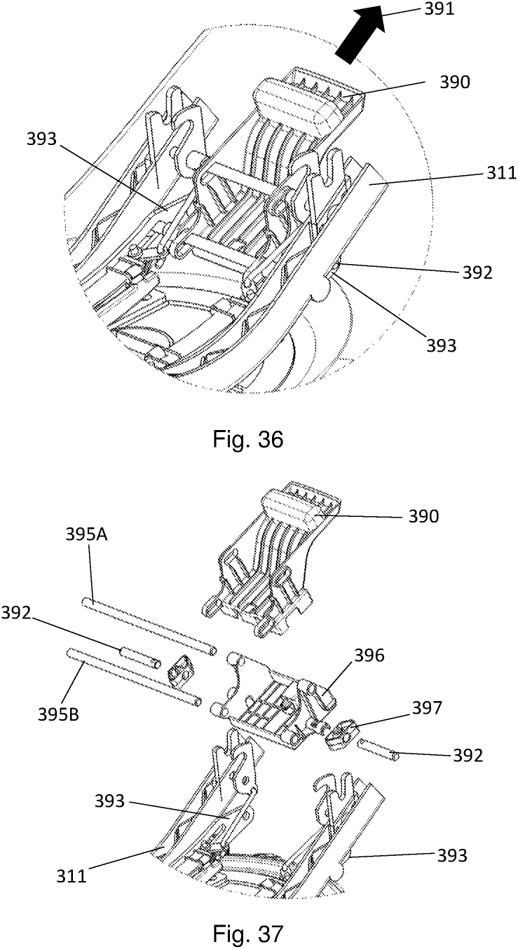

FIG. 36 is a sectional view of a recline system of the docking module shown in FIG. 18, and FIG. 37 is an exploded view of the recline system shown in FIG. 36. A recline handle 390 positioned on an underside of the shell portion between the two frame members 311. Pulling the recline handle 390 in the direction of arrow 391 causes locking pins 392 to be withdrawn from through holes in recline plates 393, such that the infant carrier module is no longer held in the current recline position and may be repositioned in a sliding manner between an upper and a recline position. Accordingly, a more comfortable arrangement may be provided, particularly for a relatively young infant.

A recline housing 396 is attached to the frame members 311 via a front locking pivot 395A and a lower recline bar 395B. The front locking pivot 395A and lower recline bar 395B pass through a recline housing 396 and hold the recline housing 396 adjacent to the frame members 311. Recline slides 397 are positioned between the recline housing 396 and each frame member 311 to allow for controlled sliding when the system is reclined. Once the system has been positioned in the desired recline position, the locking pins 392 may reengage with the recline plates 393 and hold the system securely in the desired recline position.

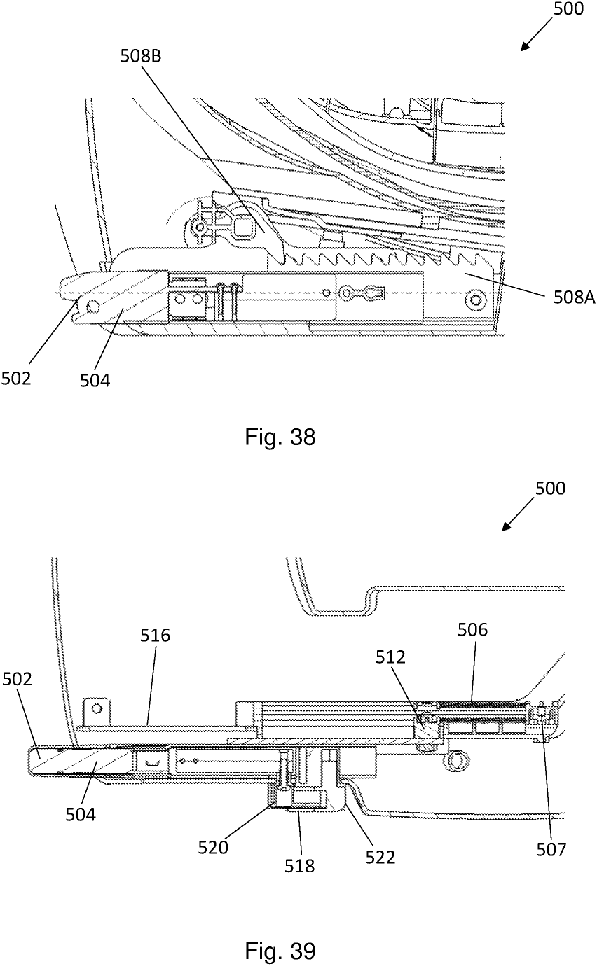

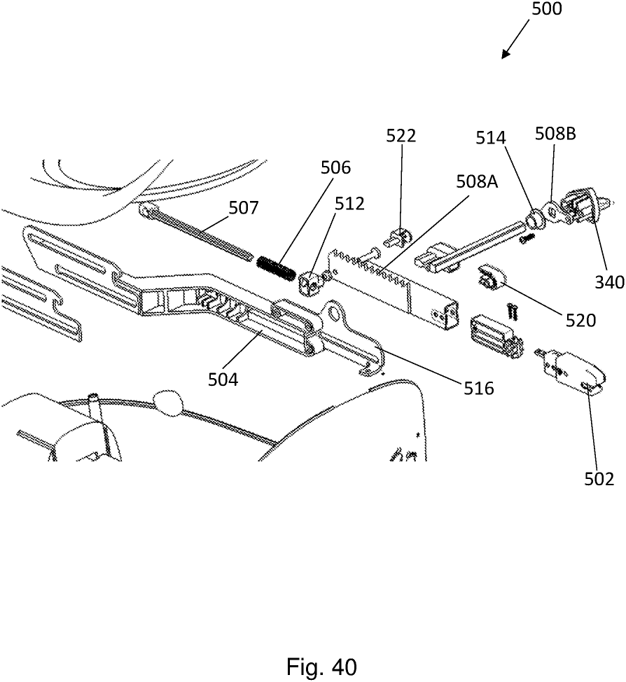

FIG. 38 is a sectional view of the ISOFIX assembly 500, FIG. 39 is a further sectional view of the ISOFIX assembly 500 shown in FIG. 38, and FIG. 40 is an exploded view of the ISOFIX assembly 500 shown in FIG. 38. The ISOFIX assembly 500 includes latches 502 configured for attachment to the vehicle in which the system is installed. The latches 502 are provided at the end of an extendable arm 504 that is moveable between a retracted position and a fully extended position. A spring 506 and elongate spring support 507 are provided to bias the arm 504 towards the fully extended position. A ratchet 508A and pawl 508B system is provided to hold the arm 504 at one of a plurality of intermediate positions between the retracted position and the fully extended position, such that further extension of the arm 504 is prevented.

The ISOFIX assembly 500 also includes a ratchet release lever 340. as discussed with reference to FIGS. 18 and 27, arranged to disengage the pawl 508B from the ratchet 508A and allow the arm 504 to extend. A slide bush 512, ratchet bush 514 and arm slide plate 516 are provided to allow for precise and smooth sliding of the arm 504 into and out of a housing 518.

To release a latch 502 from the vehicle mounting, a release button 520 and a secondary release lock 522 are provided. The secondary release lock 522 allows for the release button 520 to be actuated, and without the secondary release lock 522 being held, the release button 520 is unable to be actuated.

In use, a user may release the ratchet 508A such that the arm 504 extends out, biased by spring 506, to the fully extended position. This is done by pressing or actuating the ratchet release lever 340, which disengages the pawl 508B such that the spring 506 is free to move the arm 504. The user may then attach the latch 502 to the vehicle mounting points. The user may then push the base portion up against the back portion of the vehicle seat, causing the arms 504 to be at least partially retracted, and the ratchet 508A and pawl 508B interlock to hold the arms 504 at the desired length. To release the latches 502, the user must push and hold the secondary release lock 522 and then push the release button 520. This two factor release mechanism reduces the risk of accidental disengagement.

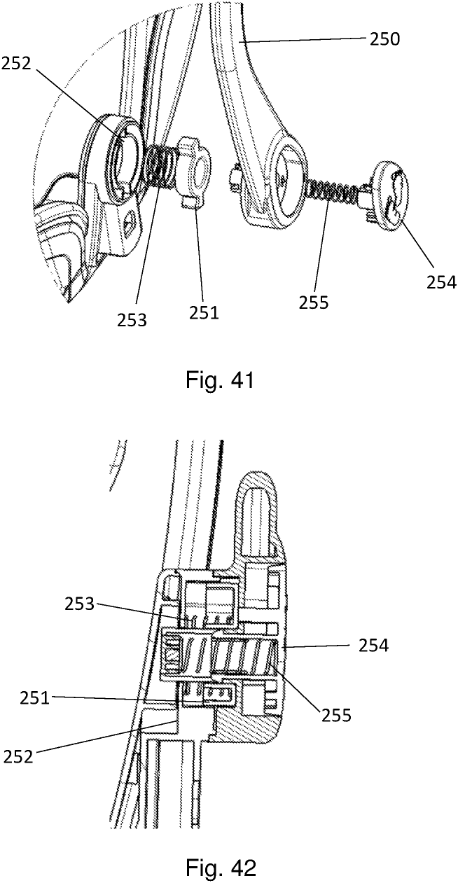

FIG. 41 is an exploded view of an infant carrier handle 250 assembly of the infant carrier module shown in FIG. 18, and FIG. 42 is a sectional view of the infant carrier handle 250 assembly shown in FIG. 41. The handle 250 is rotatable and securable in four positions via a rotatable locking cam arrangement. Other numbers of positions are envisaged. The handle assembly includes a rotation locking cam 251 including two opposed cam arms that is receivable within a corresponding handle location boss 252, including four tooth forms, arranged on the car seat. When the locking cam 251 is arranged within the location boss 252, rotation of the handle 250 relative to the remainder of the car seat is prevented. A locking cam spring 253 is provided to bias the locking cam 251 into a locked arrangement such that, at rest, rotation of the handle 250 is prevented. In order to adjust the position of the handle, a user may press and hold a handle adjustment button 254 provided on both sides of the system, which moves the locking cam 251 out of engagement with the location boss 252 and allow for rotation of the handle 250. Once the user releases the button, a release spring 255 biases the button 254 into a depressed state, such that the locking cam 251 may reengage with the location boss 252 at a different tooth form, or the next available tooth form if between two adjacent tooth forms, and hold the handle 250 in the desired position.

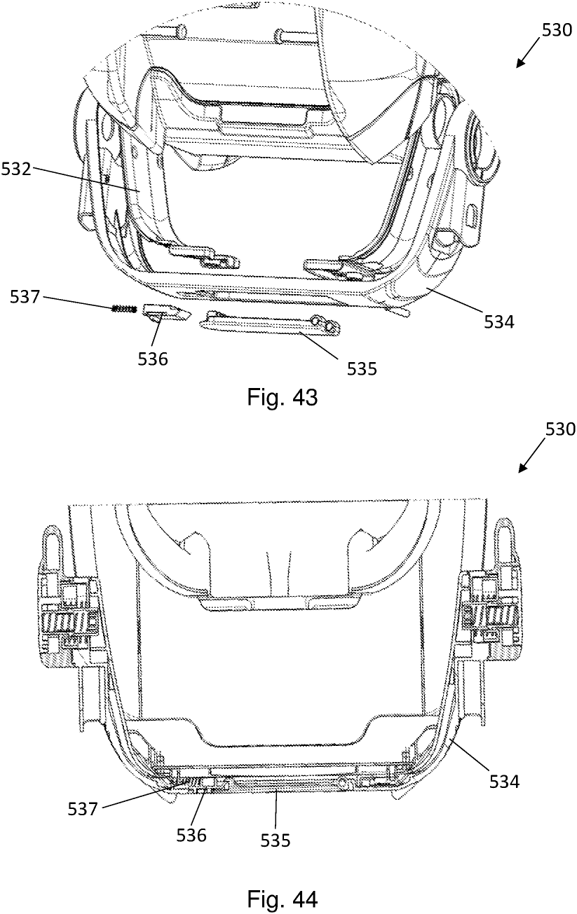

FIG. 43 is an exploded infant carrier handle removal system 530 of the infant carrier module shown in FIGS. 18 and 25, and FIG. 44 is a sectional view of the infant carrier handle removal system shown in FIG. 43, provided such that a user may remove the handle from the infant carrier module. The handle removal system 530 includes an inner handle moulding 532 configured to fit in a corresponding depression on the rear of the infant carrier module to locate the handle correctly. A corresponding outer handle moulding 534 is provided to cover the inner handle moulding 532 and the internal mechanisms of the handle removal system 530. A handle locking cam 535 is rotatably attached at one end and is rotatable by a user to release the handle such that the handle may be removed. A secondary handle lock 536 is provided to cover the free end of the handle locking cam 535 and hold the handle locking cam 535 in a locking position. The secondary handle lock 536 is slidable away from the handle locking cam 535, such that the handle locking cam 535 may be rotated, and is biased into a locking position in which the secondary handle lock 536 engages with the handle locking cam 535 by a handle locking spring 537.

To remove the handle, a user must first slide the secondary handle lock 536 away from the handle locking cam 535, against the action of the spring 537, before rotating handle locking cam 535 out approximately 90° away from the rear of the infant carrier module. The handle is therefore unlocked and may be removed.

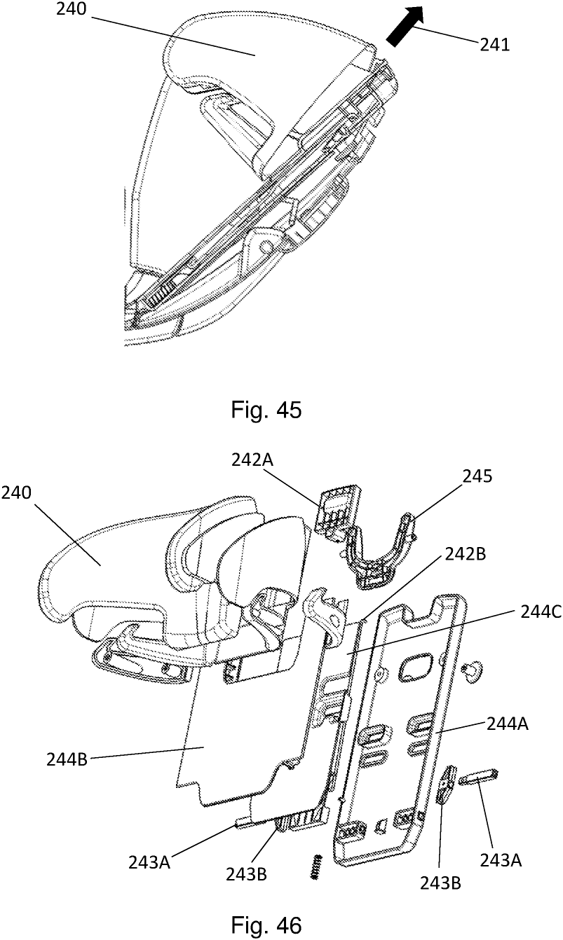

FIG. 45 is a sectional view of a headrest 240 adjustment system of the infant carrier module shown in FIG. 18, and FIG. 46 is an exploded view of the headrest 240 adjustment system shown in FIG. 45. The headrest 240 is moveable generally in the direction of arrow 241 such that, as an infant grows and becomes taller, the system may be adapted to better suit the infant. The headrest 240 is moveable in the direction of arrow 241 via two separate movement mechanisms.

The first movement mechanism is activated by pulling a release handle 242A to unlock locking pins 243A, via release wire 242B, which engage with a headrest carrier plate 244A to hold the headrest 240 stationary. Locking slides 243B are provided for each locking pin 243A. A headrest front carrier plate 244B and headrest retaining plate 244C are also provided to form a stable and secure structure for the headrest 240. The second mechanism is operable once the headrest 240 has reached the maximum possible movement via the first mechanism. The second mechanism is activated by pushing secondary headrest lever 245, allowing the headrest 240 to move to a further point.

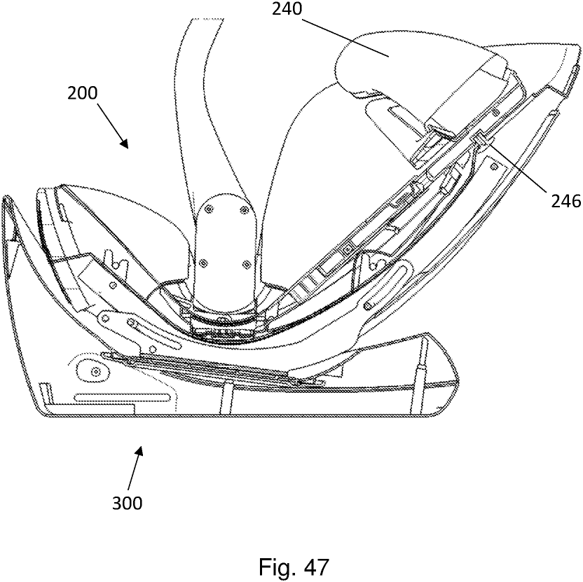

FIG. 47 is a side sectional view of a headrest 240 interlock system of the child car seat system shown in FIG. 18. The headrest 240 is slidably attached to the backrest portion of the infant carrier module 200 and is slidable away from the infant carrier module 200 such that the headrest 240 overhangs the top of the backrest portion. As described previously, the docking module 300 includes slots into which substantially mushroom shaped protrusions 246, extending from a rear surface of the headrest 240, are received. The slots include a first portion having a width larger than a greatest diameter of the mushroom shaped protrusion 246 such that the protrusions 246 may enter the slots, and a second portion having a width that is lesser than the greatest diameter of the protrusions 246. In this way, the protrusions 246 cannot be removed from the second portion of the slots. Crash loads may therefore be transferred throughout the entire system.

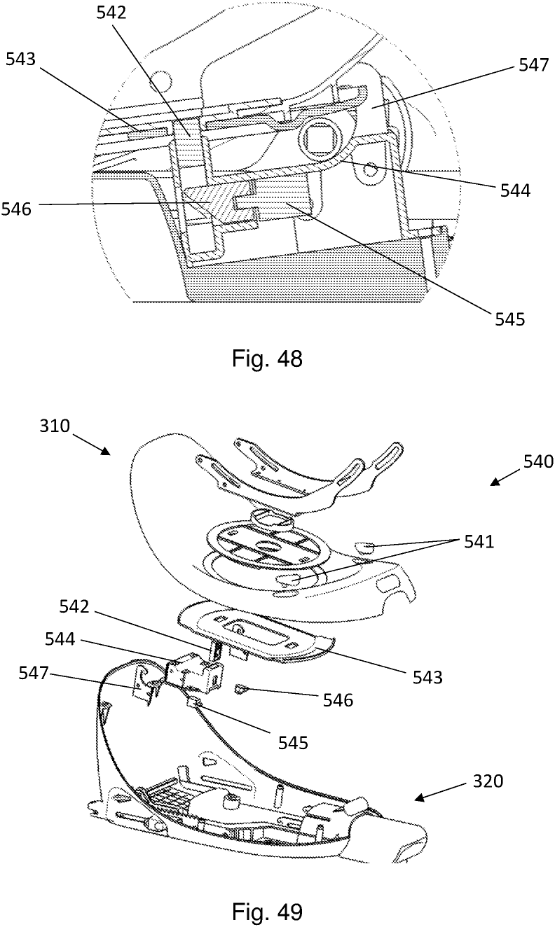

FIG. 48 is a sectional view of a rotation system 540 of the docking module 300 shown in FIG. 18, and FIG. 49 is an exploded view of the rotation system 540 shown in FIG. 48. The rotation system 540 is provided to allow the shell portion 310 to rotate relative to the base portion 320 of the docking module 300. The rotation system 540 includes activation buttons 541 operable to release a rotation lock 542 that cooperates with a rotation plate 543 to selectively prevent rotation of the shell portion 310 relative to the base portion 320. The rotation lock 542 is held within a rotation lock housing 544 and is moved by a solenoid 545, operable by the activation buttons 541, which rotates a rotation activation cam 546 to withdraw the rotation lock 542 from the rotation plate 543. The recline plates, as discussed with reference to FIGS. 36 and 37, are attached to the rotation plate 543.

The rotation system 540 is activated by pushing either of the activation buttons 541 on the top of the base portion 320. This activates the solenoid 545 which pushes the activation cam 546, which in turn pulls the rotation lock 542 out of the rotation plate 543 and allows the shell portion 310 to rotate on the base portion 320. The solenoid 545 is configured to hold the lock 542 open for 3 to 5 seconds, thus allowing the shell portion 310 to be rotated by a user. The lock 542 is spring biased so that, following the deactivation of the solenoid 545, the lock 542 will automatically engage with the rotation plate 543 and prevent further rotation of the shell portion 310 when the shell portion 310 is arranged to face forwards or rearward. The assembly 540 also forms the metal load path with rotation hooks 547 hooking over the rotation plate 543, therefore allowing crash loads to be transferred throughout the system and to the vehicle via the ISOFIX connectors.

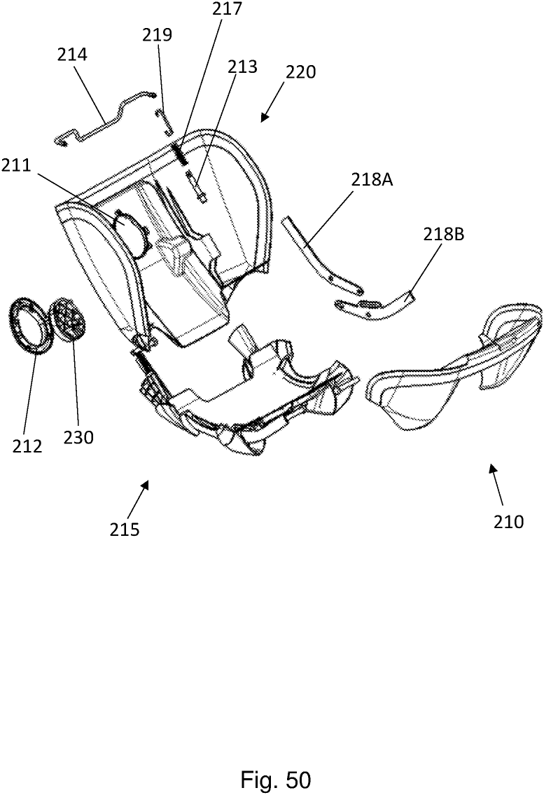

FIG. 50 is an exploded view of the infant carrier module 200 of FIG. 18. Only the external shells or supporting structures of the seat portion 210, the backrest portion 220 and the connector portion 215 are shown. A lie flat activation button 230 is provided on a rear of the shell of the backrest portion 220 in a seating aperture 211. An outer ring or cover 212 is provided to encircle and cover the lie flat activation button 230. Pressing the lie flat activation button 230 pulls a locking plunger 213 away from a tooth form in the shell of the backrest portion 220, thereby disengaging the lie flat locking mechanism. In particular, when a user presses the button 230, the button 230 actuates an activation lever 214 which pulls the plunger 213 via wire 219. The locking plunger 213 is biased towards the tooth form by a spring 217. Other components and actuators are envisaged and will be apparent from the present disclosure. The assemblies are connected by two connecting arms 218A, 218B. The connecting arms 218A, 218B allow the movement of the backrest portion 220 to drive movement of the seat portion 210, and/or an upholstered component positioned thereon.

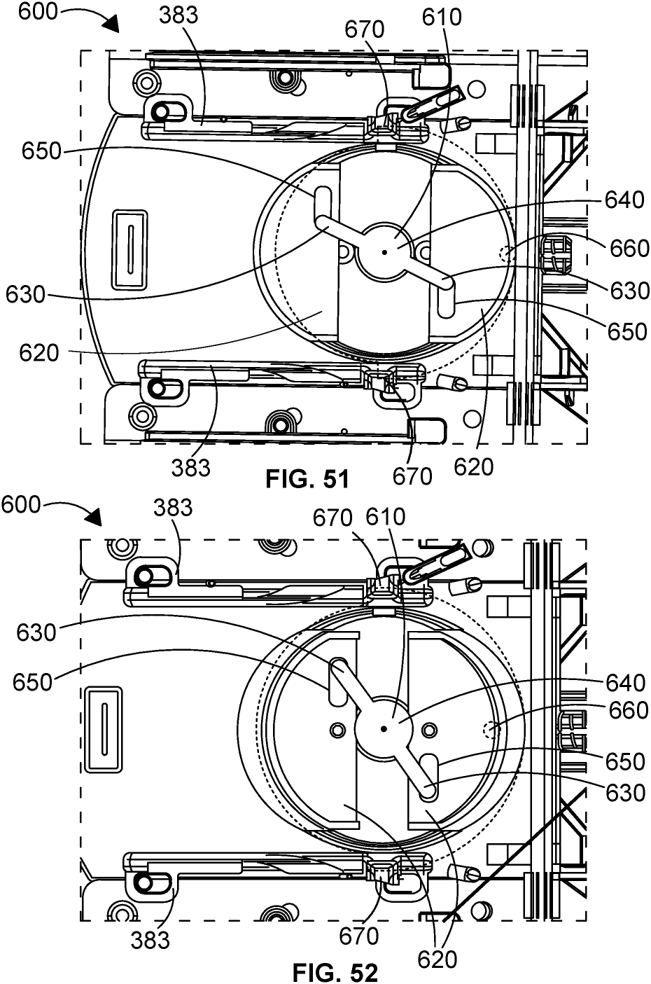

FIG. 51 is a schematic view of a rotation limiter 600 in a first position. The rotation limiter 600 may be positioned between the shell portion and the base. The rotation limiter 600 includes a rotatable selector 610 coupled to two lobes 620 having an outer edge that is curved such that the two lobes 620 together form a substantially elliptical outer surface. The selector 610 is rotatable about an axis that is parallel or coaxial with an axis about which the shell portion may rotate on the base portion, parallel to a viewing axis in the orientations shown in FIGS. 51 and 52. The lobes 620 are sliadably attached such that they are able to translate towards and away from the selector 610, in a left to right motion in the orientations shown in FIGS. 51 and 52. The selector 610 includes arms 630 extending away from a central portion 640, wherein the arms 630 engage with slots 650 on the lobes 620. The slots 650 on the lobes 620 are offset from a central portion of the lobes 620 towards a periphery of the respective lobe 620.

A first end of each slot 650 is located at a first position with a first radius relative to the axis of rotation of the selector 610, and a second end of the slot 650 is located at a second position with a second radius, greater than the first radius, relative to the axis of rotation of the selector 610. As such, rotation of the selector 610 to cause the arms 630 to move from engagement with the first end of the slot 650 to engagement with the second end of the slot 650 will cause the lobes 620 to translate relatively closer to central portion 640 of the selector 610, and vice versa.

The system further comprises a limit pin 660 arranged on a lobe 620, two limit stops 670 flanking the lobes 620 and the two docking lock release paddles 383. The docking lock release paddles are described in more detail with reference to FIGS. 32 and 33. The limit stops 670 may be arranged on the base portion such that they are held still whilst the infant carrier module rotates. Rotation of the infant carrier module, with the lobes 620 positioned in an outermost or widest position, as shown in FIG. 51, causes the lobes 620 to engage with the release paddles 383 to release the docking mechanism and allow the infant carrier module to be removed from the base portion. In this arrangement, the limit pin 660 engages with the limit stop 670 and prevents rotation of the infant carrier module beyond 90°.

The selector 610 is operable by a user to position the selector is one of three positions. The first position is shown in FIG. 51, with the lobes 620 fully extended. The selector 610 may be arranged in a second position (not shown), between the arrangements shown in FIGS. 51 and 52, in which the lobes 620 are partially retracted such that the lobes 620 do not engage with the release paddles 383, but the limit pin 660 does engage with the limit stop 670. Accordingly, in the second position, rotation of the infant carrier module may be limited by the limit pin 660, but the infant carrier module may not be released by rotating the infant carrier module to a sideways facing position.

As shown in FIG. 52, the selector 610 may be arranged in a third position in which the lobes 620 are fully retracted such that the lobes 620 are spaced from the release actuators 383 and the limit pin 660 are spaced from the limit stops 670 at all orientations of the infant carrier module. Accordingly, in the third position, the infant carrier module may be freely rotated through 360° whilst remaining locked in a docked configuration.

The infant carrier module may be restricted to rearward facing only when the selector 610 is arranged in the first or second positions. The selector 610 may be arranged in the first position only when the infant carrier module is rear facing and has the carrier handle attached. The selector 610 may be arranged in the second position only when the infant carrier module is rear facing without the carrier handle attached. The selector 610 may be arranged in the third position with the infant carrier module in any orientation, without the carrier handle.

1. A child car seat system comprising:
a docking module configured to be securable to a vehicle seat; and
an infant carrier module configured to receive an infant therein and arranged to be releasably docked with the docking module, the infant carrier module comprising a seat portion attached to a backrest portion via a locking hinge having two locking positions such that the infant carrier module is configurable in:
an upright position in which the seat portion and the backrest portion are relatively inclined at a first angle; and
a lie flat position in which the seat portion and the backrest portion are relatively inclined at a second angle, greater than the first angle;
wherein the system is configured such that the infant carrier module is adjustable within the docking module.

2. The child car seat system of claim 1, wherein the infant carrier module provides a seat structure for the child car seat system.

3. The child car seat system of claim 1, wherein the infant carrier module is configured to be docked in the docking module only when configured in the upright position.

4. The child car seat system of claim 1, wherein the infant carrier module is releasably securable in the upright position and/or the lie flat position.

5. The child car seat system of claim 4, wherein the infant carrier module further comprises a releasable locking mechanism configured to selectively secure the infant carrier module in the upright position or the lie flat position, wherein the releasable locking mechanism includes an actuator operable to release the locking mechanism and allow the relative inclination of the seat portion and the backrest portion to be adjusted.

6. The child car seat system of claim 1, wherein the infant carrier module further comprises an upholstered portion slidably attached to the backrest portion, wherein the upholstered portion is configured to translate relative to the backrest portion as the infant carrier module is reconfigured between the upright position and the lie flat position.

7. The child car seat system of claim 1, wherein the infant carrier module includes a harness configured to selectively secure an infant in the infant carrier module, further wherein the harness is stowable within the child car seat system or removable from the child car seat system when the harness is not in use.

8. The child car seat system of claim 1, wherein the infant carrier module comprises a detachable carrier handle configured to be securable to the seat portion and/or the backrest portion at a plurality of angles relative to the seat portion.

9. The child car seat system of claim 1, wherein the docking module comprises a base portion and a shell portion rotatably attached to the base portion, wherein the infant carrier module is configured to be releasably docked to the shell portion.

10. The child car seat system of claim 9, wherein the docking module comprises a forward detent configured to secure the shell portion relative to the base portion in a first rotational position, and a rearward detent configured to secure the shell portion relative to the base portion in a second rotational position that is approximately 180° rotated from the first rotational position.

11. The child car seat system of claim 10, wherein the docking module further comprises a detent release mechanism configured to release each of the detents.

12. The child car seat system of claim 10, further comprising a docking lock mechanism configured to prevent undocking of the infant carrier module from the docking module when the shell portion is secured in the first rotational position or the second rotational position.

13. The child car seat system of claim 12, wherein the docking lock mechanism is configured to automatically release when the shell portion is arranged between the first rotational position and the second rotational position.

14. The child car seat system of claim 10, wherein the shell portion is attached to the base portion via a reclining attachment mechanism configured to allow the shell portion to partially or fully recline in a translational and/or rotational manner relative to the base portion when the shell portion is arranged in the first rotational position and/or the second rotational position.

15. The child car seat system of claim 1, wherein the docking module includes a guide configured to urge the infant carrier module into a docking position.

16. The child car seat system of claim 1, further comprising a headrest attached to the backrest portion of the infant carrier module and releasably attachable to the docking module.

17. The child car seat system of claim 16, wherein the headrest is slidably attached to the backrest portion, and the docking module comprises a headrest slot, wherein, with the infant carrier module docked in the docking module, the headrest is slidable away from the backrest portion and into the headrest slot.

18. The child car seat system of claim 1, further comprising a support leg rotatably attached to the docking module, wherein the support leg is rotatable between an extended position in which the support leg extends away from the docking module, and a stowed position in which the support leg lies adjacent to the docking module along a length of the support leg.

19. The child car seat system of claim 18, wherein the support leg includes a pressure sensor configured to determine a pressure applied to a free end of the support leg such that a desired installation of the support leg is determinable, in use.

20. The child car seat system of claim 19, wherein the system is configured to provide a visual and/or audible notification when a pressure measured by the pressure sensor falls below a threshold pressure level.

21. The child car seat system of claim 18, wherein the support leg is rotatably attached to the docking module via an extendable nose, wherein the extendable nose is configured to be translatable relative to the docking module along an axis substantially perpendicular to a longitudinal axis of the support leg when the support leg is positioned in the extended position.

22. The child car seat system of claim 21, further comprising a nose lock configured to secure the extendable nose relative to the docking module.

23. The child car seat system of claim 21, wherein, with the extendable nose fully retracted into the docking module, an outer housing of the extendable nose is flush with an outer housing of the docking module.

24. The child car seat system of claim 1, wherein the docking module includes a visual indicator configured to indicate a docking status of the infant carrier module in the docking module.

25. The child car seat system of claim 1, further comprising an ISOFIX assembly for attachment to a vehicle, the ISOFIX assembly comprising an extendable arm securable at a plurality of lengths with a ratchet and pawl system, wherein the extendable arm is biased towards an arrangement in which the extendable arm has a greater length.

26. The child car seat system of claim 25, wherein the ISOFIX assembly comprises one or more switches configured to be operated upon connection of the ISOFIX assembly to the vehicle such that a connection status of the ISOFIX assembly is determinable, in use.

27. A child car seat system comprising:
a docking module configured to be securable to a vehicle seat; and
an infant carrier module configured to receive an infant therein and arranged to be releasably docked with the docking module, the infant carrier module comprising a seat portion attached to a backrest portion;
wherein the system further comprises a docking lock mechanism configured to selectively prevent undocking of the infant carrier module from the docking module.

28. The child car seat system of claim 27, further comprising a release actuator configured to be operable to release the docking lock mechanism.

29. The child car seat system of claim 28, wherein the docking module comprises a base portion and a shell portion rotatably attached to the base portion, wherein the infant carrier module is configured to be releasably docked to the shell portion.

30. The child car seat system of claim 29, wherein the docking module comprises a forward detent configured to secure the shell portion relative to the base portion in a first rotational position, and a rearward detent configured to secure the shell portion relative to the base portion in a second rotational position that is approximately 180° rotated from the first rotational position.

31. The child car seat system of claim 30, wherein the docking module further comprises a detent release mechanism configured to release each of the detents.

32. The child car seat system of claim 29, wherein the release actuator is configured to be operated automatically upon rotation of the shell portion relative to the base portion into a first release position.

33. The child car seat system of claim 32, wherein the release actuator comprises a paddle, the shell portion or the base portion comprises a paddle stop, and rotation of the shell portion relative to the base portion into the first release position causes the paddle to engage with the paddle stop such that the release actuator is actuated.

34. The child car seat system of claim 33, wherein the paddle is configured to release the docking lock mechanism when the paddle is moved in either of two opposed directions.

35. The child car seat system of claim 33, wherein the shell portion comprises at least one lobe moveable between a relative narrow position and a relative wide position, wherein the lobe is configured to engage with and operate the paddle when the shell portion is rotated relative to the base portion with the lobe in the relative wide position, further wherein the lobe is configured to be spaced from the paddle at all orientations of the shell portion with the lobe in the relatively narrow position.

36. The child car seat system of claim 35, wherein the lobe comprises a limit pin and the base portion comprises at least one limit stop, further wherein, with the lobe in the relatively wide position, the limit pin is configured to engage with the limit stop and prevent rotation of the shell portion relative to the base portion and, with the lobe in the relatively narrow position, the limit pin is configured to be spaced from the limit stop at all orientations of the shell portion.

37. The child car seat system of claim 36, wherein the lobe is positionable in an intermediate position between the relatively wide and relatively narrow positions, further wherein, with the lobe in the intermediate position, the lobe is configured to be spaced from the paddle and the limit pin is configured to engage with the limit stop.

38. The child car seat system of claim 35, further comprising a selector rotatable by a user to move the lobe between the relative narrow and relatively wide positions.

39. The child car seat system of claim 32, when dependent on claim 30, wherein the first release position is approximately 90° rotated from each of the first and second rotational positions.

40. The child car seat system of claim 39, further comprising a second release position configured to release the docking lock mechanism, wherein the second release position is approximately 180° rotated from the first release position.

41. The child car seat system of claim 40, wherein the system is arrangeable, in use, such that a child positioned in the infant carrier module is facing forwards or backwards relative to a direction of travel when the forward or rearward detent respectively, and the docking lock mechanism is configured to release when the shell portion is rotated into either sideward facing position.

42. The child car seat system of claim 27, wherein the docking module includes a visual indicator configured to indicate a docking status of the infant carrier module in the docking module.

43. The child car seat system of claim 42, wherein the visual indicator is configured to indicate a status of the docking lock mechanism such that a locked or unlocked docking status is displayed.

44. The child car seat system of claim 43, wherein the release actuator is configured to be operated automatically upon rotation of the shell portion relative to the base portion into a first release position, wherein the release actuator comprises a paddle, the shell portion or the base portion comprises a paddle stop, and rotation of the shell portion relative to the base portion into the first release position causes the paddle to engage with the paddle stop such that the release actuator is actuated, and wherein the paddle is configured to release the docking lock mechanism when the paddle is moved in either of two opposed directions, wherein the paddle is configured to operate a switch when the infant carrier module is moved to and from the first release position.

45. The child car seat system of claim 29, wherein the shell portion is attached to the base portion via a reclining attachment mechanism configured to allow the shell portion to partially or fully recline in a translational and/or rotational manner relative to the base portion when the shell portion is arranged in the first rotational position and/or the second rotational position.

46. The child car seat system of claim 27, wherein the docking module includes a guide configured to urge the infant carrier module into a docking position.

47. The child car seat system of claim 27, further comprising a headrest attached to the backrest portion of the infant carrier module and releasably attachable to the docking module.

48. The child car seat system of claim 47, wherein the headrest is slidably attached to the backrest portion, and the docking module comprises a headrest slot, wherein, with the infant carrier module docked in the docking module, the headrest is slidable away from the backrest portion and into the headrest slot.

49. The child car seat system of claim 27, further comprising a support leg rotatably attached to the docking module, wherein the support leg is rotatable between an extended position in which the support leg extends away from the docking module, and a stowed position in which the support leg lies adjacent to the docking module along a length of the support leg.

50. The child car seat system of claim 49, wherein the support leg includes a pressure sensor configured to determine a pressure applied to a free end of the support leg such that a desired installation of the support leg is determinable, in use.

51. The child car seat system of claim 50, wherein the system is configured to provide a visual and/or audible notification when a pressure measured by the pressure sensor falls below a threshold pressure level.

52. The child car seat system of claim 49, wherein the support leg is rotatably attached to the docking module via an extendable nose, wherein the extendable nose is configured to be translatable relative to the docking module along an axis substantially perpendicular to a longitudinal axis of the support leg when the support leg is positioned in the extended position.

53. The child car seat system of claim 52, further comprising a nose lock configured to secure the extendable nose relative to the docking module.

54. The child car seat system of claim 52, wherein, with the extendable nose fully retracted into the docking module, an outer housing of the extendable nose is flush with an outer housing of the docking module.

55. The child car seat system of claim 27, wherein the infant carrier module provides a seat structure for the child car seat system.

56. The child car seat system of claim 27, wherein the infant carrier module is configured to be docked in the docking module only when configured in an upright position.

57. The child car seat system of claim 27, wherein the infant carrier module is releasably securable in an upright position and/or a lie flat position.

58. The child car seat system of claim 57, wherein the infant carrier module further comprises a releasable locking mechanism configured to selectively secure the infant carrier module in the upright position or the lie flat position, wherein the releasable locking mechanism includes an actuator operable to release the locking mechanism and allow the relative inclination of the seat portion and the backrest portion to be adjusted.

59. The child car seat system of claim 27, wherein the infant carrier module further comprises an upholstered portion slidably attached to the backrest portion, wherein the upholstered portion is configured to translate relative to the backrest portion as the infant carrier module is reconfigured between an upright position and a lie flat position.

60. The child car seat system of claim 27, wherein the infant carrier module includes a harness configured to selectively secure an infant in the infant carrier module, further wherein the harness is stowable within the child car seat system or removable from the child car seat system when the harness is not in use.

61. The child car seat system of claim 27, wherein the infant carrier module comprises a detachable carrier handle configured to be securable to the seat portion and/or the backrest portion at a plurality of angles relative to the seat portion.

62. The child car seat system of claim 27, further comprising an ISOFIX assembly for attachment to a vehicle, the ISOFIX assembly comprising an extendable arm securable at a plurality of lengths with a ratchet and pawl system, wherein the extendable arm is biased towards an arrangement in which the extendable arm has a greater length.

63. The child car seat system of claim 62, wherein the ISOFIX assembly comprises one or more switches configured to be operated upon connection of the ISOFIX assembly to the vehicle such that a connection status of the ISOFIX assembly is determinable, in use.

64. A child car seat system comprising:
a docking module configured to be securable to a vehicle seat; and
an infant carrier module configured to receive an infant therein and arranged to be releasably docked with the docking module, the infant carrier module comprising a seat portion attached to a backrest portion;
wherein the infant carrier module comprises a detachable carrier handle configured to be securable to the seat portion and/or the backrest portion.

65. The child car seat system of claim 64, wherein the handle is securable at a plurality of angles relative to the seat portion.

66. The child car seat system of claim 65, wherein the handle is attached to the seat portion and/or the backrest portion via a handle attachment mechanism.

67. The child car seat system of claim 66, wherein the handle attachment mechanism comprises at least two tooth forms and a locking cam, wherein the locking cam is engageable with either of the at least two tooth forms to secure the handle in at least two angles relative to the seat portion.

68. The child car seat system of claim 67, wherein the handle attachment mechanism comprises at least four tooth forms.

69. The child car seat system of claim 67, wherein the handle attachment mechanism comprises a locking cam release actuator operable to disengage the locking cam and the tooth form.

70. The child car seat system of claim 69, wherein the locking cam release actuator comprises a biased button, wherein pushing the button moves the locking cam or tooth form out of alignment with the tooth form or locking cam respectively such that the locking cam is rotatable relative to the tooth form and the angle of the handle relative to the seat portion may be adjusted.

71. The child car seat system of claim 67, wherein the locking cam is biased towards the tooth forms such that the locking cam automatically engages with the tooth form when aligned.

72. The child car seat system of claim 66, wherein the handle attachment mechanism is configured to releasably attach the handle to the seat portion and/or the backrest portion.

73. The child car seat system of claim 72, wherein the seat portion and/or the backrest portion comprises a protrusion or a slot, and the handle attachment mechanism is configured to releasably attach to the protrusion or slot.

74. The child car seat system of claim 73, wherein the handle attachment mechanism comprises a locking cam handle rotatable between a handle locking position, in which the handle is locked to the seat portion and/or backrest portion, and a handle release portion, in which the handle is removable from the seat portion and/or the backrest portion.

75. The child car seat system of claim 74, wherein the handle attachment mechanism further comprises a cam handle retaining member configured to releasably retain the cam handle in the handle locking position.

76. The child car seat system of claim 75, wherein the cam handle retaining member is slidable between a retain position, in which actuation of the cam handle is prevented, and a release position, in which actuation of the cam handle is possible.

77. The child car seat system of claim 76, wherein the cam handle retaining member is biased towards the retain position.

78. The child car seat system of claim 64, wherein the handle is configured to attach to a rear side of the seat portion and/or backrest portion and surround the seat portion and/or backrest portion.

79. The child car seat system of claim 64, wherein the infant carrier module provides a seat structure for the child car seat system.

80. The child car seat system of claim 64, wherein the infant carrier module is configured to be docked in the docking module only when configured in an upright position.

81. The child car seat system of claim 64, wherein the infant carrier module is releasably securable in an upright position and/or a lie flat position.

82. The child car seat system of claim 81, wherein the infant carrier module further comprises a releasable locking mechanism configured to selectively secure the infant carrier module in the upright position or the lie flat position, wherein the releasable locking mechanism includes an actuator operable to release the locking mechanism and allow the relative inclination of the seat portion and the backrest portion to be adjusted.

83. The child car seat system of claim 64, wherein the infant carrier module further comprises an upholstered portion slidably attached to the backrest portion, wherein the upholstered portion is configured to translate relative to the backrest portion as the infant carrier module is reconfigured between an upright position and a lie flat position.

84. The child car seat system of claim 64, wherein the infant carrier module includes a harness configured to selectively secure an infant in the infant carrier module, further wherein the harness is stowable within the child car seat system or removable from the child car seat system when the harness is not in use.

85. The child car seat system of claim 64, wherein the docking module comprises a base portion and a shell portion rotatably attached to the base portion, wherein the infant carrier module is configured to be releasably docked to the shell portion.

86. The child car seat system of claim 85, wherein the docking module comprises a forward detent configured to secure the shell portion relative to the base portion in a first rotational position, and a rearward detent configured to secure the shell portion relative to the base portion in a second rotational position that is approximately 180° rotated from the first rotational position.

87. The child car seat system of claim 86, wherein the docking module further comprises a detent release mechanism configured to release each of the detents.

88. The child car seat system of claim 86, further comprising a docking lock mechanism configured to prevent undocking of the infant carrier module from the docking module when the shell portion is secured in the first rotational position or the second rotational position.

89. The child car seat system of claim 88, wherein the docking lock mechanism is configured to automatically release when the shell portion is arranged between the first rotational position and the second rotational position.

90. The child car seat system of claim 86, wherein the shell portion is attached to the base portion via a reclining attachment mechanism configured to allow the shell portion to partially or fully recline in a translational and/or rotational manner relative to the base portion when the shell portion is arranged in the first rotational position and/or the second rotational position.

91. The child car seat system of claim 64, wherein the docking module includes a guide configured to urge the infant carrier module into a docking position.

92. The child car seat system of claim 64, further comprising a headrest attached to the backrest portion of the infant carrier module and releasably attachable to the docking module.

93. The child car seat system of claim 92, wherein the headrest is slidably attached to the backrest portion, and the docking module comprises a headrest slot, wherein, with the infant carrier module docked in the docking module, the headrest is slidable away from the backrest portion and into the headrest slot.

94. The child car seat system of claim 64, further comprising a support leg rotatably attached to the docking module, wherein the support leg is rotatable between an extended position in which the support leg extends away from the docking module, and a stowed position in which the support leg lies adjacent to the docking module along a length of the support leg.

95. The child car seat system of claim 94, wherein the support leg includes a pressure sensor configured to determine a pressure applied to a free end of the support leg such that a desired installation of the support leg is determinable, in use.

96. The child car seat system of claim 95, wherein the system is configured to provide a visual and/or audible notification when a pressure measured by the pressure sensor falls below a threshold pressure level.

97. The child car seat system of claim 94, wherein the support leg is rotatably attached to the docking module via an extendable nose, wherein the extendable nose is configured to be translatable relative to the docking module along an axis substantially perpendicular to a longitudinal axis of the support leg when the support leg is positioned in the extended position.

98. The child car seat system of claim 97, further comprising a nose lock configured to secure the extendable nose relative to the docking module.

99. The child car seat system of claim 97, wherein, with the extendable nose fully retracted into the docking module, an outer housing of the extendable nose is flush with an outer housing of the docking module.

100. The child car seat system of claim 64, wherein the docking module includes a visual indicator configured to indicate a docking status of the infant carrier module in the docking module.

101. The child car seat system of claim 64, further comprising an ISOFIX assembly for attachment to a vehicle, the ISOFIX assembly comprising an extendable arm securable at a plurality of lengths with a ratchet and pawl system, wherein the extendable arm is biased towards an arrangement in which the extendable arm has a greater length.

102. The child car seat system of claim 101, wherein the ISOFIX assembly comprises one or more switches configured to be operated upon connection of the ISOFIX assembly to the vehicle such that a connection status of the ISOFIX assembly is determinable, in use.

103. A child car seat system comprising:
a docking module configured to be securable to a vehicle seat; and
an infant carrier module configured to receive an infant therein and arranged to be releasably docked with the docking module, the infant carrier module comprising a seat portion attached to a backrest portion;
wherein the system further comprises a headrest attached to the backrest portion of the infant carrier module and releasably attachable to the docking module.

104. The child car seat system of claim 103, wherein the headrest is slidably attached to the backrest portion, and the docking module comprises a headrest slot, wherein, with the infant carrier module docked in the docking module, the headrest is slidable away from the backrest portion and into the headrest slot.

105. The child car seat system of claim 104, wherein the headrest comprises a headrest protrusion on a rear side thereof configured to be received within the headrest slot.

106. The child car seat system of claim 105, wherein the headrest protrusion comprises an enlarged head, and the headrest slot comprises a first portion having a width larger than a width of the enlarged head and a second portion having a width lesser than the width of the enlarged head.

107. The child car seat system of claim 105, wherein the docking module comprises two headrest slots and the headrest comprises two protrusions.

108. The child car seat system of claim 103, wherein the system further comprises a headrest locking mechanism configured to releasably prevent movement of the headrest relative to the backrest portion.

109. The child car seat system of claim 108, wherein the headrest locking mechanism comprises at least one locking pin configured to releasably engage with the headrest and prevent movement of the headrest.

110. The child car seat system of claim 109, wherein the locking pin is biased towards a position in which the locking pin engages with the headrest.

111. The child car seat system of claim 109, wherein the system further comprises a headrest release actuator coupled to the locking pin and operable to disengage the locking pin from the headrest.

112. The child car seat system of claim 111, wherein the headrest release actuator is coupled to the locking pin via a headrest release component.

113. The child car seat system of claim 104, wherein a shell portion including the headrest slot is moveable relative to the backrest portion such that the headrest may, in use, make a secondary movement relative to the backrest portion whilst positioned in the headrest slot.

114. The child car seat system of claim 113, wherein the system further comprises a secondary headrest lever operable to release the shell portion including the headrest slot.

115. The child car seat system of claim 103, wherein the infant carrier module provides a seat structure for the child car seat system.

116. The child car seat system of claim 103, wherein the infant carrier module is configured to be docked in the docking module only when configured in an upright position.

117. The child car seat system of claim 103, wherein the infant carrier module is releasably securable in an upright position and/or a lie flat position.

118. The child car seat system of claim 117, wherein the infant carrier module further comprises a releasable locking mechanism configured to selectively secure the infant carrier module in the upright position or the lie flat position, wherein the releasable locking mechanism includes an actuator operable to release the locking mechanism and allow the relative inclination of the seat portion and the backrest portion to be adjusted.

119. The child car seat system of claim 103, wherein the infant carrier module further comprises an upholstered portion slidably attached to the backrest portion, wherein the upholstered portion is configured to translate relative to the backrest portion as the infant carrier module is reconfigured between an upright position and a lie flat position.

120. The child car seat system of claim 103, wherein the infant carrier module includes a harness configured to selectively secure an infant in the infant carrier module, further wherein the harness is stowable within the child car seat system or removable from the child car seat system when the harness is not in use.

121. The child car seat system of claim 103, wherein the infant carrier module comprises a detachable carrier handle configured to be securable to the seat portion and/or the backrest portion at a plurality of angles relative to the seat portion.

122. The child car seat system of claim 103, wherein the docking module comprises a base portion and a shell portion rotatably attached to the base portion, wherein the infant carrier module is configured to be releasably docked to the shell portion.

123. The child car seat system of claim 122, wherein the docking module comprises a forward detent configured to secure the shell portion relative to the base portion in a first rotational position, and a rearward detent configured to secure the shell portion relative to the base portion in a second rotational position that is approximately 180° rotated from the first rotational position.

124. The child car seat system of claim 123, wherein the docking module further comprises a detent release mechanism configured to release each of the detents.

125. The child car seat system of claim 123, further comprising a docking lock mechanism configured to prevent undocking of the infant carrier module from the docking module when the shell portion is secured in the first rotational position or the second rotational position.

126. The child car seat system of claim 125, wherein the docking lock mechanism is configured to automatically release when the shell portion is arranged between the first rotational position and the second rotational position.

127. The child car seat system of claim 123, wherein the shell portion is attached to the base portion via a reclining attachment mechanism configured to allow the shell portion to partially or fully recline in a translational and/or rotational manner relative to the base portion when the shell portion is arranged in the first rotational position and/or the second rotational position.

128. The child car seat system of claim 103, wherein the docking module includes a guide configured to urge the infant carrier module into a docking position.

129. The child car seat system of claim 103, further comprising a support leg rotatably attached to the docking module, wherein the support leg is rotatable between an extended position in which the support leg extends away from the docking module, and a stowed position in which the support leg lies adjacent to the docking module along a length of the support leg.

130. The child car seat system of claim 129, wherein the support leg includes a pressure sensor configured to determine a pressure applied to a free end of the support leg such that a desired installation of the support leg is determinable, in use.

131. The child car seat system of claim 130, wherein the system is configured to provide a visual and/or audible notification when a pressure measured by the pressure sensor falls below a threshold pressure level.

132. The child car seat system of claim 129, wherein the support leg is rotatably attached to the docking module via an extendable nose, wherein the extendable nose is configured to be translatable relative to the docking module along an axis substantially perpendicular to a longitudinal axis of the support leg when the support leg is positioned in the extended position.

133. The child car seat system of claim 132, further comprising a nose lock configured to secure the extendable nose relative to the docking module.

134. The child car seat system of claim 132, wherein, with the extendable nose fully retracted into the docking module, an outer housing of the extendable nose is flush with an outer housing of the docking module.

135. The child car seat system of claim 103, wherein the docking module includes a visual indicator configured to indicate a docking status of the infant carrier module in the docking module.

136. The child car seat system of claim 103, further comprising an ISOFIX assembly for attachment to a vehicle, the ISOFIX assembly comprising an extendable arm securable at a plurality of lengths with a ratchet and pawl system, wherein the extendable arm is biased towards an arrangement in which the extendable arm has a greater length.

137. The child car seat system of claim 136, wherein the ISOFIX assembly comprises one or more switches configured to be operated upon connection of the ISOFIX assembly to the vehicle such that a connection status of the ISOFIX assembly is determinable, in use.

138. A child car seat system comprising:
a docking module configured to be securable to a vehicle seat; and
an infant carrier module configured to receive an infant therein and arranged to be releasably docked with the docking module, the infant carrier module comprising a seat portion attached to a backrest portion via a connector portion, wherein the connector portion comprises at least one locking hinge having two locking positions such that the infant carrier module is configurable in:
an upright position in which the seat portion and the backrest portion are relatively inclined at a first angle; and
a lie flat position in which the seat portion and the backrest portion are relatively inclined at a second angle, greater than the first angle.

139. The child car seat system of claim 138, further comprising a carrier handle releasably attachable to the connector portion.

140. The child car seat system of claim 138, wherein the connector portion comprises one or more sockets configured to receive and releasably retain a protrusion therein such that the infant carrier module is releasably attachable to a wheeled frame comprising one or more protrusions.

141. The child car seat system of claim 138, wherein the seat portion is rotatably attached to a first side of the connector portion and the backrest portion is rotatably attached to a second side of the connector portion.

142. The child car seat system of claim 138, wherein the infant carrier module comprises a lie flat activation button actuable by a user to disengage the locking hinge and allow the infant carrier module to be configured to the lie flat position.

143. The child car seat system of claim 138, wherein the infant carrier module comprises an upholstered component slidably attached to one or more of the seat portion, the backrest portion and the connector portion, and one or more lie flat connecting arms, wherein the lie flat connecting arms are attached at a first end to the upholstered section and at a second end to the seat portion or backrest portion such that reconfiguring the infant carrier module between the upright position and the lie flat position moves the upholstered component.
